(19) United States
(12) Patent Application Publication
(10) Pub. No.: US 2011/0085632 A1
(43) Pub. Date: Apr. 14, 2011

(54) SYSTEMS AND METHODS FOR MAGNETICALLY ASSISTED INERTIAL ELECTROSTATIC CONFINEMENT FUSION

(75) Inventors: Alexander Klein, Boston, MA (US); Scott Rackey, Bedford, MA (US)

(73) Assignee: FP Generation

(21) Appl. No.: 12/900,918

(22) Filed: Oct. 8, 2010

Related U.S. Application Data
(60) Provisional application No. 61/250,470, filed on Oct. 9, 2009.

(51) Int. Cl. H05H 1/02

(52) U.S. Cl. 376/129

(57) ABSTRACT

In one embodiment, a nuclear fusion-generating device includes a cathodic magnet having a polyhedral structure formed from current-carrying leg sections and adapted to generate a multi-poled magnetic field such that the curvature of the magnetic field lines are everywhere convex within a magnet interior region. An ion generating system injects ions into a center of the magnet interior region at energies favoring a nuclear fusion cross-section of the ions. The current-carrying elements can be powered and configured to confine electrons into the center of the magnet interior region to function as a cathode that neutralizes ionic space charges and facilitates ion movement along paths that do not intersect solid structures. The current-carrying elements can be formed with a radial-to-azimuthal aspect ratio that favors increased transparency to the ions without sacrificing magnetic field strength.

### RELATED APPLICATION

This application claims priority to and the benefit of, and incorporates herein by reference in its entirety, U.S. Provisional Patent Application No. 61/250,470, which was filed on Oct. 9, 2009.

### TECHNICAL FIELD

The present invention relates, generally, to systems and methods for inertial electrostatic confinement fusion. More particularly, various embodiments relate to a fusion-generating device employing advantageous magnetic and electrostatic design configurations for increased ion and/or electron confinement and reduced energy loss.

### BACKGROUND

Fusion energy has been the object of numerous research efforts. The long-term goal of many researchers has been the development of a fusion reactor design capable of generating net power in order to provide cheap, abundant power to the world without burning fossil fuels. The two methods most thoroughly pursued have involved the magnetic confinement and heating of thermal plasmas to bring a fusion reactive gas to very high temperatures and pressures (magnetic confinement), and the fast compression of fusion fuel pellets using laser or particle beams to achieve high temperatures and pressures in the fuel (inertial confinement). Both of these approaches have inherent difficulties associated with them, which have so far prevented the construction of a device that can actually produce net power.

However, fusion reactions have utility beyond that of net power generation. In fact, devices that achieve fusion reactions are nowadays commercially available. As magnetic and inertial confinement schemes are of a scale and cost that render them generally infeasible for commercial application, these commercial devices employ alternative means of generating fusion reactions. Typically, they involve accelerating a beam of deuterium ions to fusion energies, and then letting the beam impact onto a suitable solid state target which may comprise tritium. Further, at least one commercial supplier is currently offering devices based on “inertial electrostatic confinement,” which is described in detail below. These fusion-generating devices have a plethora of practical applications, including, but not limited to, material diagnostics, security screening (e.g., screening of shipping containers), and down-hole oil well logging (i.e., in situ evaluation of hydrocarbon content in the strata nearby an oil well bore hole).

Inertial electrostatic confinement (IEC) constitutes a subclass of confinement schemes that achieve fusion reactions by collisional interactions of fusion-reactive ion beams. In IEC, ion beams are self-collided in a spherical or cylindrical geometry. Conventionally, this approach has involved purely electrostatic means for accelerating and containing the relevant charged particles (i.e., ions and electrons). However, more recent IEC schemes have also involved magnetic structures for the magnetic insulation of the accelerating electrostatic structures.

A simple IEC device is illustrated schematically in FIG. 1. This device 100 includes a spherical cathode 102, which is permeable to particle flow, surrounded by a concentric spherical anode 104. Ions 106 are accelerated between the anode 104 and the cathode 102 by means of an electric field established between the two by a voltage source 108. As the ions 106 penetrate the inner cathode 102, their inertia keeps them moving radially inwards, towards the center of the device 100, where some of them collide. The collision between two ions 106 may cause them to fuse to form a heavier isotope (in the process emitting energetic fusion products 110), or may cause elastic Coulomb scattering. The non-colliding or non-fusing ions keep traversing the cathodic space, and as long as they do not collide with the cathode structure itself, emerge on the opposing side of the cathode 102, where they begin to travel towards the anode 104. In the process, they are slowed down until they turn completely around and are accelerated again toward the cathode 102. Thus, small ion input current can give rise to substantial recirculating ion currents in the device 100.

FIG. 2 shows the radial profiles of the electrostatic potential and ion density in the device 100. These profiles illustrate a limitation of this configuration: positive space charge in the center. Any significant number of ions converging to a point will slow each other down by virtue of their mutual electric repulsion. The ionic space charge forms a “virtual” anode. This effect limits the energy and/or density of the colliding ions in the center of the device. Another limitation is posed by the grid wires of the cathode 102. Being a physical structure, the cathode 102 is not completely permeable to particle flow. As a result, ions have a limited lifetime and a finite number of orbits before they strike the cathode structure and are lost. Particle impact onto the cathode 102 heats the cathode, and may, at high energies and currents, result in the destruction of the cathode grid (which is typically constructed of refractory metal wires). Enhanced grid structures have achieved geometric transparencies (i.e., ratios of open spherical area to total spherical area, of about 90 percent, which allow an average ion recirculating current of five to ten times that of the injected ion current.

To overcome the space-charge problems, electrons may be introduced into the device to neutralize the ion charges, so that an arbitrarily high ion density can be achieved while the overall particle charge is kept neutral (or nearly neutral). To this end, the cathode grids are sometimes designed to emit electrons. These electrons are attracted by the positive space charge of the ions and enter the inner volume of the cathode, where they act to neutralize the ionic charges to some degree. However, electrons 112 (FIG. 1) are also repelled by the grid wires. Thus, when they find their way outside of the cathode, they are quickly accelerated to the anode, where they represent a substantial energy drain.

Various approaches for diminishing the physical obstructions presented by the cathode grid wires have been proposed. One approach involves ion motion along stable, star-like orbits that do not intersect the grid. This “star-mode” may be induced by electrons (formed by ionization and/or cathode-grid emission) that escape through openings in the cathode grid. Since they are electro-statically repelled by the grid wires, these electrons tend to accumulate along axes through the centers of the openings, where they set up their own space charge, attractive to ions, thereby forming “ion channels” upon which the ions ride in and out of the inner cathodic region. The escaping electron beams may also ionize neutral fusion reactive gas, and thus give birth to ions that form an ion channel. However, just as ions ride in and out of the cathode along the channels, the electrons do as well. Thus, electrons may impact the cathode, or otherwise leave the device, in copious rates, thereby causing significant energy losses.

An alternative approach involves replacing the physical cathode structure by a “virtual” cathode, created by injecting electrons into a spherical space about the center of the anode. By injecting small ion currents into this configuration, a large recirculating ion current may be achieved. However, the electrons now become the primary energy loss mechanism, and the electron currents required to maintain the virtual cathode have been determined to be unrealistically large. In addition, a certain class of instabilities that would limit the magnitude of recirculating ion currents to levels too low to cause significant numbers of fusions reactions have been predicted.

Various proposals for reducing the electron input requirements for devices with virtual cathodes have been directed to insulating the (real) anode structures with magnetic fields. In particular, several researchers have studied multi-pole magnetic confinement of the ion-electron plasma. In this approach, magnetic fields are created such that the plasma sees a set of spherically arranged magnetic “mirrors,” formed by converging magnetic field lines. Using more than two such field arrangements, the curvature of the magnetic field may be rendered completely convex from the point of view of the confined plasma, which ensures magneto-hydrodynamic (MHD) stability. The multi-pole magnetic field may be created by electromagnetic coils or permanent magnets arranged on the faces of polyhedra (typically uniform convex polyhedra). In certain embodiments, the magnetic field decreases to a minimum in the center of the device. In general, plasmas tend to diffuse towards regions of weaker magnetic fields; therefore, this magnetic topology is particularly suitable for plasma confinement. It is free of so-called “macro” instabilities, i.e., instabilities that may be predicted from simple fluid models of plasma confinement. In order to function as a virtual cathode, the plasma needs to be net-negative, i.e., the number of electrons needs to exceed the number of ions in the center region. To overcome the resulting electrostatic repulsion for electrons, the electrons are injected at sufficiently high velocities. The higher the velocity, on the other hand, the more likely is it that an electron can escape the magnetic confinement. This inherent conflict presents a major obstacle for the efficient operation of such devices.

### SUMMARY

The present invention provides systems and methods for confining ions and electrons, for the purpose of generating fusion reactions, using novel containment configurations that combine electrostatic and magnetic elements. In various embodiments, the systems and methods improve upon the state of the IEC fusion reactor art by increasing the stability of ion orbits and the frequency of fusion reactions, and/or reducing energy losses. A fusion reactor, fusion device, or fusion-generating device, as the terms are used interchangeably herein, refers to a device capable of inducing fusion reactions, regardless of whether such device achieves net power.

In general, fusion-generating devices in accordance with various embodiments of the invention are based on the electrostatic acceleration of ions between a negatively-biased polyhedral magnet (hereinafter variously referred to as the “polyhedral magnet,” “cathodic magnet,” or simply the “magnet”) and a surrounding anode (i.e., a surrounding structure held at an electrostatic potential that is positive relative to the cathodic magnet). In some embodiments, the anode is formed by the walls of a vacuum chamber in which the magnet is suspended. Typically, the anode and cathodic magnet are quasi-spherical concentric structures. (“Quasi-spherical” indicates, consistently with the general use of the term in the physical disciplines, that the structures may deviate from spherical geometries as long as they exhibit a degree of spherical symmetry. For example, a regular polyhedron is considered quasi-spherical.)

The magnet may comprise a number of permanent magnetic or current-carrying electromagnetic structural elements that are arranged along the edges or faces of a polyhedron and define an (empty) interior region. The magnet generates a multi-poled magnetic field having magnetic field lines whose curvature is everywhere convex within the interior region, and serves to confine electrons that are injected towards the center of the interior region. In some embodiments, the cathodic magnet is constructed of structures that are highly transparent to incoming ion particles with radial velocities, yet substantial enough to allow for large currents or magnetization to provide substantial magnetic fields (on the order of 0.01 Tesla or greater). In particular, the magnetic elements may have a high radial-to-azimuthal aspect ratio (i.e., may form radially extending structures that occupy little surface area on a sphere and leave significant space-angular openings). In addition to facilitating a strong magnetic field, the radial depth of the cathodic magnet also increases the electrostatic field strength, as compared with that of wire grid cathodes. Specifically, it reduces “droop” in the potential near the center of the polyhedral faces.

Positive ions are injected into the device by one or more ion sources that are disposed about the anode and aligned on geometric axes passing through the center of the magnet and the centers of the polyhedral faces (hereinafter referred to as the axes of the polyhedron). Ions emerging from the ion sources are accelerated toward the center of the magnet along said axes by the negative potential of the magnet relative to the anode and/or ion source. The polyhedral magnet is of such a shape that an axis that passes through both the center of one face of the polyhedron and the center of the magnet will also pass through a polyhedral face on the opposite side of the polyhedral magnet. Thus, an ion that is accelerated toward the center of the magnet, if it does not fuse with another particle or impact the magnet structure itself during its pass through the magnet, will pass back out of the magnet on the opposite side from where it entered. The ion will then slow down as it climbs back out of the electrostatic potential well and eventually turns around for another pass.

The multi-poled magnetic field generated by the cathodic magnet facilitates the confinement of electrons within the interior region of the magnet. The confined electrons may provide three functions: First, they may neutralize the positive space charge of the ions as the ions converge at the center of the magnet, thereby enabling greater ion densities. Second, they may create a negative potential well that, in turn, enables the creation of a relatively dense and low temperature ion-electron plasma trapped at the center, which can increase the number of fusion targets and thereby the overall fusion power of the device. Third, the electrons may concentrate about the centers of the faces of the polyhedral magnet and thus create space-charge lenses (so-called Gabor lenses). These lenses have the effect of both focusing ions toward the center of the device, thereby increasing density still further, and modifying the trajectories of ions so that they do not impact the magnet, thereby allowing a greater number of re-circulations and thus an even higher ion density at the center. The increases in ion density, in turn, enable greater numbers of fusion reactions for a given device, as fusion reactions occur in proportion to the square of the ion density. The magnetic field, in and of itself, need not be sufficient to confine the ions. Rather, it suffices if the magnetic field confines and shapes a population of electrons that in turn keeps the ions on trajectories that do not intercept the solid structure of the magnet, thereby increasing the chance that the ions will undergo fusion reactions.

Various additional features can be included. For example, to further increase the frequency of fusion reactions, a low-temperature ion plasma may be trapped in the interior region of the magnet, where the trapped ions act as fusion targets for the higher-energetic recirculating ions. Further, to reduce energy losses due to high-energy ions impacting the anode, the fusion reactor may include an ion deselector subsystem that removes, with minimal energy cost, ions that have trajectories more likely to result in an impact. Similarly, electron absorbers may be used to re-capture “hot” electrons. To diminish the likelihood of electron impact on the magnet, electron repellers may be installed at the magnet.

In a first aspect, the invention provides a device for generating fusion reactions, which device includes a cathodic magnet, an anode surrounding the cathodic magnet, one or more ion sources, one or more electron emitters, and one or more electron absorbers (whereby, in certain embodiments, the same physical component may serve as both an electron emitter and an electron absorber). The cathodic magnet is configured to generate a multi-poled magnetic field within an interior region thereof. The ion sources are located about the anode, and configured to emit ions (e.g., protons, deuterons, tritons, helium-3 ions, boron-11 ions, and/or lithium ions) substantially toward the center (i.e., into a small region around the mathematical center) of the interior region, typically, through at least one of the space-angular openings. Both the electron emitter(s) and the electron absorber(s) are located about the cathodic magnet. The emitters are configured to emit electrons into the interior region, and absorbers are configured to absorb electrons that have energies exceeding a certain energy threshold from the interior region. The cathodic magnet and anode together are configured to generate therebetween an electric field for accelerating the ions substantially toward the center of the interior region.

The cathodic magnet may be formed of or include radially extending elements that define space-angular openings. These elements may include current-carrying wire coils, and have an aspect ratio (i.e., a ratio of the number of windings in the radial direction to the number of windings in the azimuthal direction) equal to or greater than 1. Further, elements may be shaped substantially as envelopes of truncated cones. The cathodic magnet may have a polyhedral topology. The cathodic magnet and electron emitters together may be configured to concentrate electrons about the center of the interior region and about centers of the faces of the polyhedron.

The electron absorber(s) may be configured to reduce energy loss due to (i) electron impact on the cathodic magnet and/or (ii) electron escape from the interior of the cathodic magnet. In some embodiments, the electron absorbers each include a plate that is located near an inner radius of a radially extending element. For example, the plates may be ring plates aligned substantially coaxially with the space-angular openings. The device may further include one or more electron repellers located about the cathodic magnet, for example, proximate the space-angular openings. In some embodiments, the electron repeller is negatively biased relative to the cathodic magnet. Moreover, the device may include one or more ion-deselector located at an interior of the anode. The ion-deselector(s) may be negatively biased relative to the anode.

In certain embodiments, the device includes one or more secondary ion sources located about the cathodic magnet and configured to emit fusion fuel into the interior region, and/or one or more sources of neutral fusion gas located about the anode. The description of elements of the embodiments of other aspects of the invention can be applied to this aspect of the invention as well.

In a second aspect, the invention provides a fusion-generating device including a cathodic magnet, configured to generate a multi-poled magnetic field within an interior region, which defines openings at faces of a polyhedron, an anode surrounding the cathodic magnet, at least one ion source, and at least one electron emitter. The cathodic magnet and the electron emitter(s) are configured to concentrate electrons about the center of the interior region and about centers of the faces of the polyhedron, which in turn may concentrate the ions onto paths substantially coinciding with axes of the polyhedron and/or focus the ions into a region about the center of the cathodic magnet. The description of elements of the embodiments of other aspects of the invention can be applied to this aspect of the invention as well.

In a third aspect, the invention is directed to a fusion-generating device which includes, in addition to a cathodic magnet surrounded by an anode and one or more electron emitters located about the magnet, primary and secondary ion sources. The primary ion source(s) are located about the anode and configured to emit ions substantially toward a center of the interior region. The secondary ion source(s) are located about the cathodic magnet and configured to emit fusion fuel (for example, including ions, neutral atoms, and/or neutral molecules that may be subsequently ionized) into the interior region. Together, the electron emitter(s), secondary ion source(s), and cathodic magnet are configured so that a substantially neutral plasma formed by the electrons and the fusion fuel is substantially confined within the interior region. An electric field generated between the anode and cathodic magnet may be configured to accelerate the ions to a hot-ion temperature, which may be higher than the temperature of the substantially neutral plasma. The description of elements of the embodiments of other aspects of the invention can be applied to this aspect of the invention as well.

In a fourth aspect, the invention provides a method including the use of a device as described above to generate fusion reactions. The method may involve generating a multi-poled magnetic field; emitting electrons into the interior region of the cathodic magnet; absorbing electrons having energies exceeding an energy threshold from the interior region; injecting ions substantially toward the center of the interior region; generating an electric field between the anode and the cathodic magnet; reducing energy loss due to electron impact on the cathodic magnet and/or electron escape from the interior of the cathodic magnet; emitting fusion fuel into the interior region; forming a neutral plasma including electrons and fusion fuel; concentrating electrons about the center of the interior region and about centers of the faces of the polyhedron; and/or concentrating ions onto paths substantially coinciding with axes of the cathodic magnet and/or focusing the ions into a region about the center of the cathodic magnet. The description of elements of the embodiments of other aspects of the invention can be applied to this aspect of the invention as well.

In a fifth aspect, the invention provides a device for generating fusion reactions, which device includes a cathodic magnet, an anode surrounding the cathodic magnet, at least one source of ions or ion precursors (which may be configured to emit the ions or ion precursors substantially toward a center of the interior region), one or more electron emitters, and one or more electron absorbers (whereby, in certain embodiments, the same physical component may serve as both an electron emitter and an electron absorber). The cathodic magnet is configured to generate a multi-poled magnetic field within an interior region thereof. Both the electron emitter(s) and the electron absorber(s) are located about the cathodic magnet. The emitter(s) are configured to emit electrons into the interior region, and the absorber(s) are configured to absorb electrons that have energies exceeding a certain energy threshold from the interior region. The cathodic magnet and anode together are configured to generate therebetween an electric field for accelerating the ions substantially toward the center of the interior region. The source of ions or ion precursors may include a source of neutral fusion gas, and may further include means for ionizing the neutral fusion gas. The description of elements of the embodiments of other aspects of the invention can be applied to this aspect of the invention as well.

In a sixth aspect, the invention is directed to a device for generating fusion reactions that includes a cathodic magnet configured to generate a multi-poled magnetic field within an interior region thereof and defining openings at faces of a polyhedron, an anode surrounding the cathodic magnet, one or more sources of ions or ion precursors, and at least one electron emitter located about the cathodic magnet and configured to emit electrons into the interior region. The anode and the cathodic magnet are configured to generate an electric field therebetween for accelerating the ions substantially toward the center of the interior region. The cathodic magnet and the at least one electron emitter are configured to concentrate electrons about the center of the interior region and about centers of the faces of the polyhedron. The description of elements of the embodiments of other aspects of the invention can be applied to this aspect of the invention as well.

In a seventh aspect, the invention provides a device for generating fusion reactions that includes a cathodic magnet configured to generate a multi-poled magnetic field within an interior region thereof, an anode surrounding the cathodic magnet, primary and secondary sources of fusion fuel, at least one primary ion source located about the anode and configured to emit ions substantially toward a center of the interior region, and at least one electron emitter configured to emit electrons into the interior region and at least one secondary ion source configured to emit fusion fuel into the interior region, both the at least one electron emitter and the at least on secondary ion source being located about the cathodic magnet. The anode and the cathodic magnet are configured to generate an electric field therebetween for accelerating the ions substantially toward the center of the interior region, and the at least one electron emitter, the at least one secondary ion source, and the cathodic magnet are configured so that a substantially neutral plasma formed by the electrons and the fusion fuel is substantially confined within the interior region. The primary source of fusion fuel may include one or more ion sources located about the anode and configured to emit ions substantially toward a center of the interior region. The secondary source of fusion fuel may include at least one source of neutral fusion gas, and/or at least one ion source located about the cathodic magnet and configured to emit ions toward the center of the interior region. In some embodiments, the primary and secondary sources of fusion fuel are sources of neutral fusion gas, the primary source is located about the anode, and the secondary source is located about the cathodic magnet.

### BRIEF DESCRIPTION OF THE DRAWINGS

The foregoing and other features and advantages of the invention will be apparent from the following detailed description of illustrative embodiments in conjunction with the accompanying drawings, in which:

FIG. 1 is a schematic drawing of the anode and cathode grid structures of a prior-art IEC device;

FIG. 2 is a diagram showing ion density and electrostatic potential radial profiles in the device of FIG. 1;

FIG. 3A is a cut-away view of a fusion-generating device in accordance with one embodiment;

FIG. 3B is an exploded view of the device shown in FIG. 3A;

FIG. 3C is a perspective view of an electron emitter in accordance with one embodiment;

FIG. 3D is a cut-away close-up view of a magnet with associated electron absorbers in accordance with one embodiment;

FIG. 4 is an enlarged cross-section view of a cathodic magnet and associated elements of a fusion-generating device in accordance with one embodiment;

FIG. 5A is a conceptual diagram of the current paths about the edges of an octahedron such as to create an octahedral multipole magnetic field;

FIG. 5B is a conceptual diagram of round current paths inscribed within the faces of an octahedron such as to create an octahedral multipole magnetic field;

FIG. 5C is schematic drawing of conical current-carrying elements arrayed about the vertices of a cube in accordance with one embodiment;

FIG. 6 is a schematic drawing of cylindrical windings distributed about the faces of a cube and energized with such polarities as to create a multipole magnetic field of a truncated-cube topology in accordance with one embodiment;

FIG. 7A is a plot of the computationally derived B-field strengths along two axes of a truncated-cube multi-poled magnetic field as a function of distance from the center of a multipole magnet in accordance with one embodiment;

FIG. 7B is a contour plot of magnetic field strength on a plan intersecting the center of a truncated-cube multi-poled magnetic field in accordance with one embodiment;

FIG. 8A is a drawing illustrating the components of a conical magnet element in accordance with one embodiment;

FIG. 8B is a detailed cross-section view of a conical magnet element in accordance with one embodiment;

FIG. 8C is a drawing illustrating an octahedral magnet constructed of eight conical magnet elements in accordance with one embodiment;

FIG. 8D is a drawing illustrating an octahedral magnet assembly in accordance with one embodiment;

FIG. 8E is a drawing illustrating an octahedral magnet assembly yet more fully assembled in accordance with one embodiment;

FIG. 9 is a simulation plot showing plasma electrons confined to a core region and a Gabor lens region in accordance with one embodiment;

FIG. 10 is a plot of the electrostatic potential of the Gabor lens of FIG. 9;

FIG. 11 is a detailed cross-section view of one octant of a cathodic magnet, ion deselector electrode, and ion source in accordance with one embodiment;

FIG. 12 is a graph illustrating a double potential well in accordance with one embodiment that may be formed by a combination of ions and electrons at the center of a multi-poled field;

FIG. 13 is cut-away view of an experimental setup in accordance with one embodiment;

FIG. 14 is a perspective view of a multipole magnet assembly in accordance with one embodiment;

FIG. 15 is a cut-away view of a single magnet hemisphere of the multipole magnet depicted in FIG. 14;

FIG. 16 is a graph showing computed and measured magnetic field strengths of a magnet in accordance with one embodiment;

FIG. 17 is a cut-away view of a full beam line of a fusion generating device in accordance with one embodiment;

FIG. 18 is a sample output of a computational simulation showing that the beam line configuration substantially similar to that depicted in FIG. 17 stably traps ions on recirculating orbits; and

FIG. 19 is a perspective view of a fusion generating device in accordance with one embodiment.

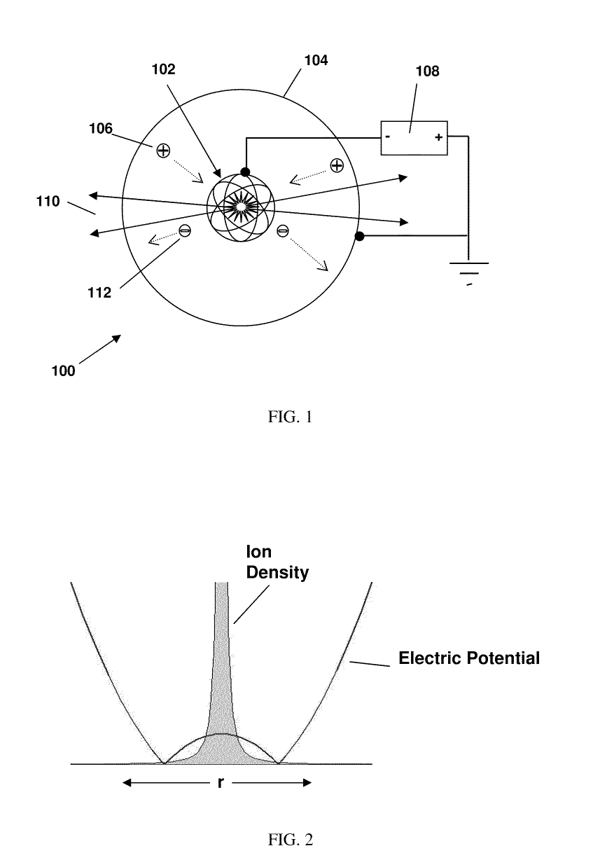

In the drawings, like references generally refer to the same or similar functional components of the device; implementation details of the respective components may, however, vary between the embodiments depicted in different drawings.

### DETAILED DESCRIPTION

It is contemplated that methods, systems, and processes described herein encompass variations and adaptations developed using information from the embodiments described herein.

Throughout the description, where devices and systems are described as having, including, or comprising specific components, or where processes and methods are described as having, including, or comprising specific steps, it is contemplated that, additionally, there are devices and systems of the present invention that consist essentially of, or consist of, the recited components, and that there are processes and methods of the present invention that consist essentially of, or consist of, the recited processing steps.

The mention herein of any publication, for example, in the Background section, is not an admission that the publication serves as prior art with respect to any of the claims presented herein. The Background section is presented for purposes of clarity and is not meant as a description of prior art with respect to any claim.

Headers are used herein to aid the reader and are not meant to limit the interpretation of the subject matter described.

### 1. System Overview

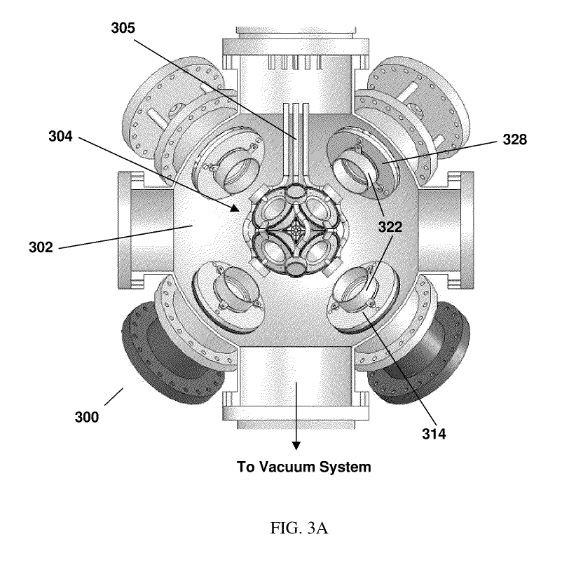

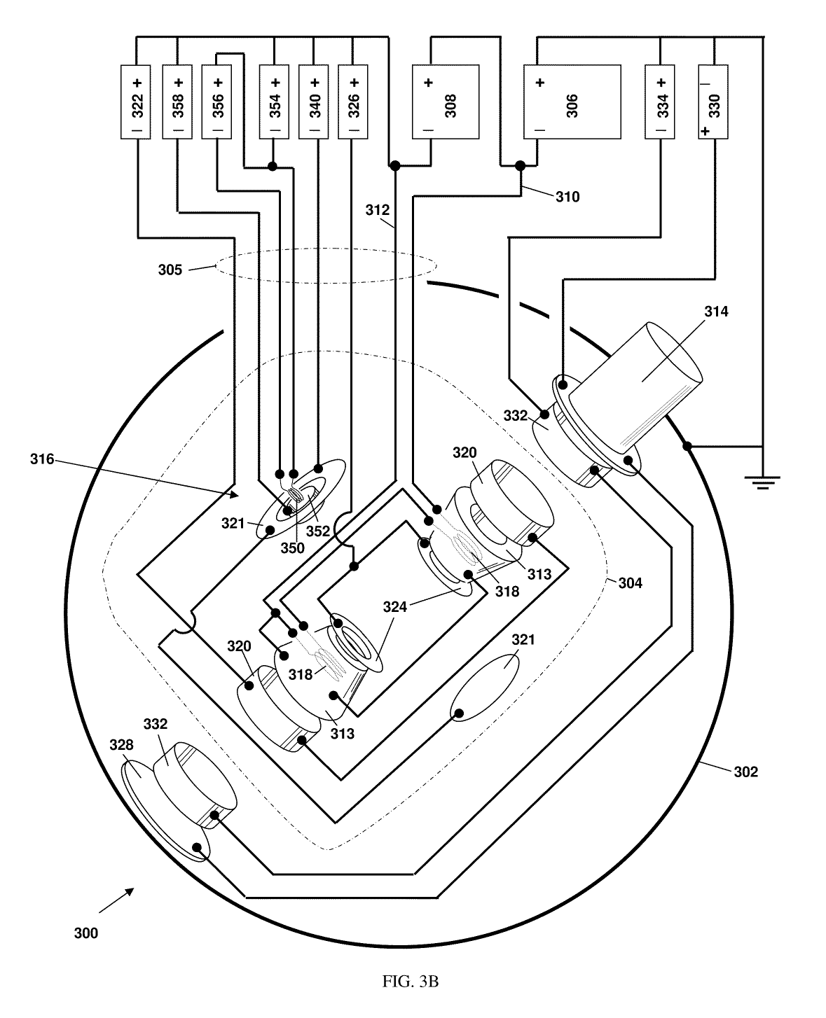

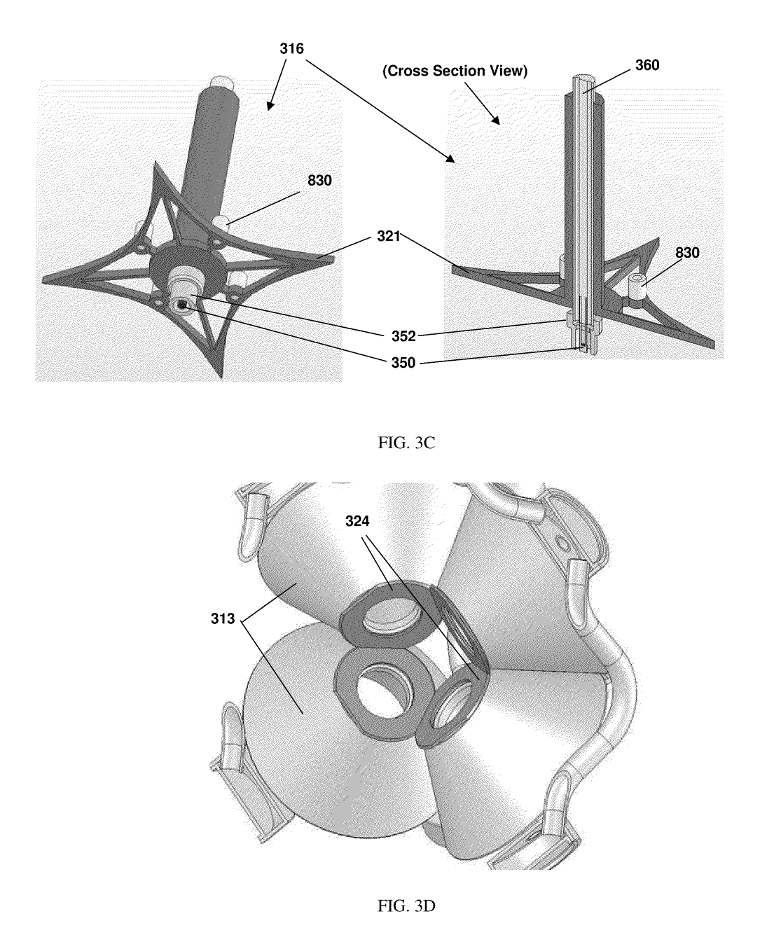

An exemplary embodiment of a fusion device in accordance with various embodiments is shown in a cut-away view in FIG. 3A, and illustrated schematically in more detail in an exploded view in FIG. 3B. The device 300 includes a spherical vacuum chamber 302 having a diameter of, typically (but not necessarily), between 25 and 100 cm. The level of vacuum in the chamber 302 may be less than 1×10⁻⁴ Torr in order for the neutral collisional mean free path of ions to greatly exceed the dimensions of the device. The chamber 302 may be electrically conductive (at least at its interior surface) and may serve as one electrode surface, specifically, as an anode. In alternative embodiments, in lieu of using the wall of the vacuum chamber 302, the anode may be provided by a conducting shell or mesh (not shown) within the vacuum chamber, or without such a chamber if the device is operated in a high-vacuum environment such as outer space.

Located within the center of the chamber 302 is a magnet 304. In FIG. 3A, an eight-face magnet is shown (which magnet may be wired for either octahedral or truncated cube magnetic topologies, explained further below), but any appropriate polyhedral topology may be used. FIG. 3B shows just a single beam line for clarity, but should also be considered representative of devices with more than one beam line on different axes. It should be noted that items inside of the dash-dot line in FIG. 3B are all considered part of the magnet 304. The magnet 304 may be positioned in the central region of the vacuum chamber 302 by a stalk or stem structure 305, and may be coated with a vacuum-compatible material with low sputtering coefficient to prevent local particle erosion. At least a portion of the outer surfaces of the magnet 304 is electrically conductive, and held at a large negative potential (e.g., 100,000 volts) with respect to the anode by a high-voltage d.c. power supply 306 external to the vacuum chamber 302. Thus, the exterior of the magnet serves as the second electrode, i.e., the cathode, and an electric field is established between the cathodic magnet 304 and the anode (e.g., the interior wall of the chamber 302).

In some embodiments, the cathodic magnet 304 includes current-carrying elements forming electromagnet conductors 318. In other embodiments, the cathodic magnet is formed of permanent magnet elements. In still other embodiments, the cathodic magnet includes both permanent and electromagnetic elements. In the case of an electromagnet, a low-voltage, high-current d.c. power supply 308 may be provided to energize the conductors 318. In certain embodiments, the stem structure 305 includes a first conductor 310 that is connected to both the negative output of the high-voltage d.c. power supply 306 and the positive output of the low-voltage, high-current d.c. power supply 308, and a second conductor 312 that is connected to the negative output of the low-voltage, high-current power supply 308, the current-carrying elements 318, and the conductive skins 313 containing the current-carrying elements 318. The cathode function of the cathodic magnet 304 is thus facilitated by the same high current flow that produces the electromagnetic effect because the skins of the individual magnet elements are held at an even more negative potential by the potential of the power supply 308. In other embodiments, the first conductor 310 is electrically connected directly to the conductive skins 313, thereby aiding design simplicity by creating a local “high voltage common bias” against which other magnet subsystems (e.g., magnet coils, repellers, emitters, etc.) can reference their respective potentials. A closed-loop cooling system may be used to remove excess heat from the cathodic magnet 304 using a suitable coolant, such as water. For example, the stalk 305 may include passages for such a coolant fluid. Furthermore, the electromagnet conductors may reside within the passages for the coolant.

The magnet is configured so as to generate a suitable multi-pole magnetic field for confining electrons while being sufficiently transparent to ion trajectories. A typical field strength, suitable for confining electrons having an initial injection energy of about 1 keV in a region of 7 cm in diameter, is about 0.1 T. The magnet 304 may be formed of electrical current-carrying elements 318 that wrap at least once around the axes of the polyhedron, and are oriented so as to conduct currents substantially parallel to the faces of the (idealized) polyhedral structure. The current-carrying elements 318 define openings (or “throats”), which may be substantially circular in shape when viewed radially toward the center of the device, i.e., along the axes of the polyhedron. When electrical current is applied to the current-carrying elements, the resulting magnetic field is characterized by field lines that extend through the openings and around the field-generating elements. Since the magnet comprises tangible solid structures of some finite volume, a portion of the area of at least some of the faces of the idealized polyhedron is occluded. This occlusion may be minimized. Preferably, it does not exceed 90%; more preferably, it does not exceed 50%, and still more preferably, it does not exceed 30%. The current-carrying elements may, in some embodiments, include magnetic windings. The term “windings” is used herein to refer to wound conductors and should be considered a subset of current-carrying elements.

Around the periphery of the vacuum chamber 302, a number of ion sources 314 may be arranged. The ion sources may provide positively charged ions (in some cases completely stripped of electrons), charged molecules, neutral atoms, neutral molecules, or a mixture thereof, of a fusion-reactive gas such as deuterium, tritium, boron, hydrogen, lithium, helium-3, or a mixture thereof. Neutral particles may be ionized by bombardment with charged particles (such as, e.g., electrons) near the anode, by the electric field between the cathode 304 and the anode itself, or by electrons and/or ions in or about the cathodic magnet. The ions have a net positive charge, and therefore experience an accelerating force towards the cathodic magnet 304 due to the electric field. As the ions are accelerated towards the magnet, they may be focused by the electric field about and within the openings of the polyhedral magnet, and/or by local electron concentrations (described further below) near the centers of these openings.

In some embodiments, for each face in the cathodic magnet structure 304, an ion source 314 is provided. In other embodiments, ion sources are provided for only a portion of such faces. In either case, the axis of emission of any ion source 314 may be substantially aligned with an axis of the polyhedron. In general, the faces for which ion sources are provided will be aligned with opposite symmetric faces on the polyhedral magnet. Thus, an ion may travel in a continuous straight line beginning from the ion source, entering the center of one face of the polyhedral magnet, passing through the center of the magnet, and exiting the magnet through the center of the opposite polyhedral face. Two ion sources may be located at opposite sides of the vacuum chamber. Alternatively, an axis along which ions travel may be provided with a single ion source at one end and an ion reflector 328 at the opposite end as shown in FIG. 3B. The ion reflector 328 may include any suitable conductor material, and may be electrically biased such that a substantial number of ions approaching from the respective nearest aligned face on the magnet are unable to overcome the potential of the ion reflector, and are thus slowed to the point where they change direction and head back toward the magnet. Alternatively, the reflector may be constructed of an insulating material, which may be charged by ions initially impacting the insulator to a potential sufficiently positive such that subsequently approaching ions are reflected. Ions traveling from the magnet substantially along polyhedral axes toward an ion source may be similarly slowed and turned around by the potential of the ion source. FIG. 3B shows the ion source 314 and the ion reflector 328 held at the same bias, with such bias created by the power supply 330; this is a non-limiting example. In some embodiments, the potential of the vacuum chamber itself may be sufficiently positive to reflect the ions, and power supply 330 would not be necessary.

Further, in some embodiments, the anode (e.g., the inner wall of the vacuum chamber) incorporates ion deselectors 332 where ions that have been sufficiently scattered into undesirable regions of velocity space are removed from the system without as large an energy cost as would have been incurred, had the ions been accelerated to and impacted on the cathodic magnet. Such ion deselectors 332 may be biased either positively or negatively relative to the chamber 302 by power supply 334. FIG. 3B shows the ion deselectors 332 negatively biased. The ion deselectors 332 can also serve as focusing electrodes whose potentials adjusts the overall potential profile of the “turn-around region” of the ions (see region 1100 in FIG. 11) such that the reflected ion trajectories are either better focused as they pass through the magnet, or otherwise adjusted to keep the ions on trajectories that do not intercept the magnet.

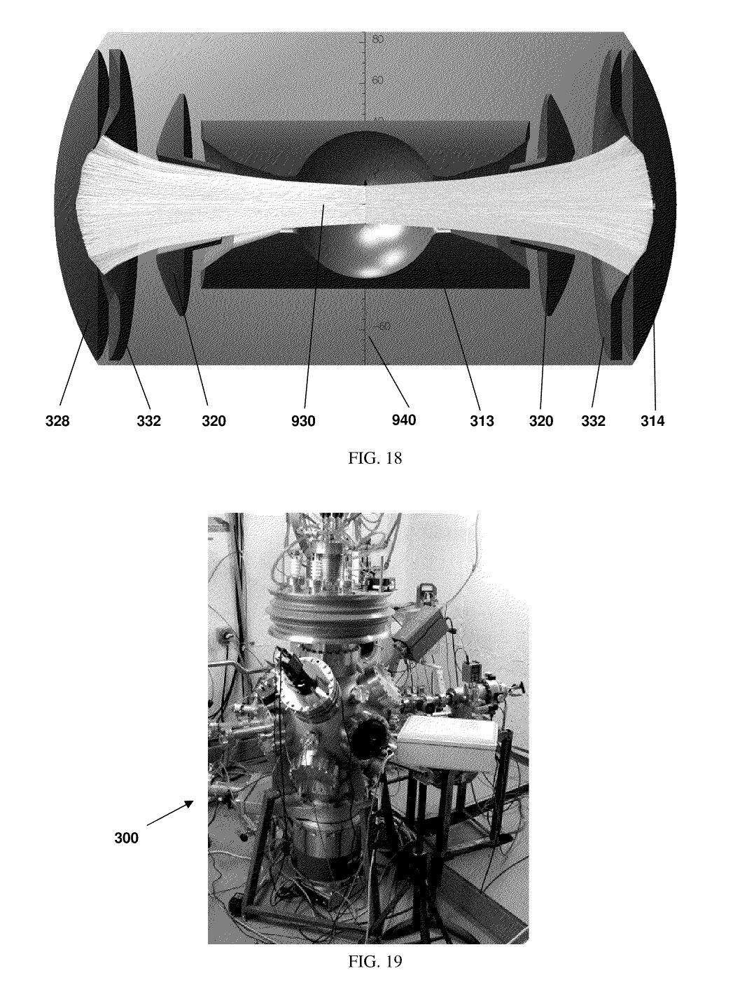

In general, the ion reflector 328 and the ion deselector 332 may have any shape that is effective at creating an electrostatic configuration (and associated “ion optical” properties) that keeps ions on recirculating orbits (i.e., achieves “stable trapping” as described below). As non-limiting examples, the reflector may be a flat plat or a concave spherical surface, and the deselector electrode may be a short, wide tube, or a thin, truncated cone approximating the electrostatic equipotential surface that would exist at the deselector's location if the deselector electrode were not part of the system. (FIG. 18 shows an example of a deselector electrode 332 shaped to approximate said equipotential surface.)

When ion beams are passing through the core, a positive ionic space charge potential typically develops around the beams and especially around the intersection point of the beams at the core. In some embodiments of this invention, electrons serve to at least partially neutralize this space charge, which would otherwise form a potential “hill” that would slow ions and reduce fusion rates by lowering the ion density and velocity, and/or would cause “beam blow-up” where the beam is defocused by its own space charge. Due to the high driving potential involved, electrons are usually present in the system due to secondary emission, ion collisions, field emission, and/or other mechanisms, and some portion of these electrons generally become confined within the core of the cathodic magnet 304. However, in preferred embodiments, dedicated electron injectors directly inject electrons into the interior region of the magnet 304 in order to assure a sufficient population of electrons in the core.

The electrons may generally be injected from any location where they are neither immediately absorbed by the magnet 304 itself, nor accelerated away from the magnet toward the anode. Typically, electron injection is performed either from the vertices of the polyhedral magnet 304 where the faces of the magnet intersect, or from one or more faces of the polyhedral magnet that have been reserved for electron injection and thus do not have ion beams passing through them. FIGS. 3B and 4 show the cathodic magnet 304 with a dedicated electron emitter assembly 316. When the current-carrying elements 318 are wired for the octahedral magnetic topology, the electron emitter assembly axis is located on a field null extending from the core. When the current-carrying elements 318 are wired for the truncated cube magnetic topology instead, the electron emitter assembly axis is located on a magnetic mirror, as described further below. Analogous embodiments are also envisioned wherein electron emitters are located on magnetic nulls or magnetic mirrors for higher-order polyhedra.

The wiring of the electron emitter assembly is detailed in FIG. 3B. The emitter 350 itself may be made from a heated filament, a heated LaB6 crystal, or some other typical electron emitter. This emitter is brought up to a bias relative to the magnet skin bias 312 by power supply 354. The bias can be used to (at least partially) control the temperature of the electrons introduced to the confinement region of the magnet. Inasmuch as the emitter 350 re-absorbs the electrons, such bias also sets the energy above which electrons may be re-absorbed, since electrons of lower energy will not be able to get back to the emitter. In some embodiments, the emitter may be powered with power supply 356 in order to heat it (e.g., via a filament embedded within the emitter or part of the emitter) to a temperature where electrons are emitted. In some embodiments, the electrons may be accelerated away from the emitter via a repeller electrode 352 that is biased relative to the magnet skin potential 312 by power supply 358. In most cases, this potential is positive relative to that of the emitter. The mechanical construction of the emitter assembly 316 for the truncated-cube configuration is detailed in FIG. 3C. Electrical leads for the emitter and the accelerating electrode (not shown) may be carried out of, and may be electrically insulated from, the magnet 304 via insulating lead carrier 360. The emitter assembly 316 may also comprise an alternate repeller 321 to prevent electrons from escaping from the interior region of the magnet, the importance of which is described below.

The electrons within the confinement region are attracted to the positive ionic space charge, and may populate the core region to neutralize the ionic space charge. The electrons are thus in part electrostatically confined, and may build in number until the ionic space charge is fully neutralized. In some embodiments, the electron charge eventually exceeds the ionic charge, and thus forms a virtual cathode within the interior region of the magnet 304 (which functions as the “real” cathode). The virtual cathode may contribute to accelerating and focusing the energetic ion beams.

When the electron charge exceeds the ion charge, the electrons are confined in large part by the magnetic field of the cathodic magnet. The cathodic magnet 304 produces a multi-pole magnetic field, in which the lines of constant magnetic field strength are arranged quasi-spherically about the center of the cathodic magnet geometry, and in which the field intensity decreases to zero at the core of the system. This magnetic field configuration serves to confine a plasma with inherent stability properties. It may cause substantial numbers of electrons to dwell within the core region about the center of the magnet 304 and extending in some regions toward, and, in some embodiments, into the faces of the polyhedral magnet (hereinafter collectively referred to as the “confinement region”). The confinement of electrons within the interior of the magnet 304 is important because, otherwise, electrons would escape from the magnet, resulting in a large energy loss, as those electrons which escape the magnet are then immediately accelerated to high energy away from the magnet by the large potential between the magnet and the chamber 302 and/or ion source(s) 314. This, in turn, would lead to a large power drain on the high-voltage power supply 306 that creates the high potential between the magnet and the chamber. In some embodiments, therefore, the confinement provided by the magnetic field is supplemented by electrostatic electron repellers 320 located about the magnet, as shown in FIGS. 3B, 4, and 8B. An additional power supply 322 (shown in FIG. 3B) may be provided to appropriately bias the electron repellers relative to the magnet (e.g., by 5 kV). In some embodiments, different repeller geometries and biases may be used for certain polyhedral faces. For example, in the truncated-cube topology, some polyhedral faces are occupied by round conical magnetic coils, and the electron repellers 320 take the shape of conical tubes as well. However, for other polyhedral faces, repellers may take on other shapes, as may be convenient to set up an appropriate potential gradient for the electrons. These alternate repellers 321 are shown in FIGS. 3B and 4. FIG. 3B shows that these alternate repellers may be separately biased by power supply 340.

In addition to confining a substantial population of electrons in the interior region of the magnet, thereby reducing electron losses, the magnetic field may facilitate electron density profiles that encourage stable orbits for recirculating ions. Specifically, the magnetic field may cause the electron density to build at the turning points for electrons that are reflected by the magnetic field in the openings of the magnet. At these turning points, the radial velocity of the electrons goes to zero, and, due to conservation of current, the resultant density of electrons is high in these regions (electrons spend more time in regions where they are slow, as opposed to regions where they travel swiftly; ergo, the density of electrons must be higher in the regions where they are slow). This electron population distribution will form Gabor lenses, which serve to keep ions focused in stable orbits as is described in more detail below.

The electron density profile may further be shaped by conductors capable of absorbing electrons (which may, but need not simultaneously serve as electron emitters). These electron absorbers 324, shown in FIG. 3B (and in the cut-away view of the magnet shown in FIG. 3D), may be held at a desired electric potential, for example, using a power supply 326 or resistor network (variable or otherwise). The dedicated electron emitters 316 inherently serve additionally, at least to some extent, as electron absorbers.

The recapture of electrons by electron absorbers also provides another important function: Any population of electrons, if left undisturbed, will quickly take on a Maxwellian distribution of energies (e.g., through Coulomb scattering). A fraction of the electrons in the “fast tail” of this distribution will have sufficient energies to overcome the confinement of the magnetic field and any electrostatic repulsive field (e.g., as created by electron repellers). Electrons that escape the confinement region either impact the magnet itself, resulting in minor energy losses, or accelerate away from the magnet and impact the chamber (or other elements at or nearer to the chamber potential), resulting in substantial energy losses. However, in various embodiments, the electron emitters and absorbers and the magnetic field are collectively configured such that the developing “fast tail” of the distributions is, at least in part, recaptured by the absorbers and/or emitters. Thereby, the “fast tail” is effectively removed from the distribution. Careful placement of electron absorbers in susceptible areas of the magnet (e.g., covering a portion of the surfaces of the magnet facing the core) may reduce losses by absorbing electrons at a lower energy penalty than if the electrons contacted the magnet itself. Such placement of electron absorbers 324 is shown in the cut-away view of the magnet shown in FIG. 3D. Computer simulations have shown that such use of electron absorbers may reduce the energy cost due to electrons hitting the magnet by a factor of about 500. In using electron absorbers, the potential and the geometry of the absorbers may be optimized to balance the repulsion of electrons (which could diminish the cathodic potential of the trapped electron population and reduce ion beam focusing or trapped low-energy ion densities, thereby reducing fusion power) and the losses of electrons to the magnet or out of the mirrors (which would create an energy penalty).

The benefits of the combination of a multi-poled magnet with integrated electron emitters and/or absorbers, and optionally also electron repellers, are that a population of electrons is confined and shaped such that (i) the electron density is increased, thereby more effectively neutralizing the ionic space charge and preventing beam blow-up, slowing of ions, and limiting of ion densities, and (ii) the electron density is higher in preferred locations of the confinement zone along the axes of the polyhedron, thereby forming Gabor lenses that prevent ion de-focusing in the interior of the magnet and redirect ions away from trajectories that could result in collisions with the magnet. The resultant ion orbits in such configurations are very stable in the sense that it takes many traversals through the device before a particular ion develops significant momentum in the transverse, non-radial direction. In certain embodiments, the average number of traversals before this occurs will be in excess of 50 transits through the machine. Therefore, the recirculating ion current may greatly (i.e., by a factor in excess of 50) exceed the injected ion current. Computer simulations have indicated that the average number of recirculations may exceed 10,000. Since the number of fusion reactions per unit time is, in some embodiments, proportional to the (recirculating) ion current raised to the second power, various embodiments may produce more fusion reactions than has been previously achieved for a given input current and voltage (power) in IEC devices.

In some embodiments, the number of fusion reactions per unit time is further increased by a low-temperature ion population confined in the interior region of the magnet by the magnetic field and/or the attractive potential of the electron population. Such a low-temperature ion population may be formed by neutral fusion gas that is ionized in the interior region, or by ions directly injected inside the interior region (i.e., ions that do not traverse the electric field between the cathode and anode). Neutral (i.e., un-ionized) fusion fuel is generally present within the vacuum chamber in some amount, e.g., due to leakage of un-ionized gas from the ion sources and/or neutralization of energetic ions through charge exchange. However, neutral fusion gas may also be introduced intentionally at appropriate rates (e.g., rates low enough to not overwhelm the vacuum system). Regardless of how it is introduced into the device, some portion of the neutral gas wanders into the core region, where it may become ionized by any one of a number of mechanisms, including, but not limited to, collisions with confined electrons, collisions with confined ions, and collision with energetic ions passing through the core. If a neutral atom or molecule has a sufficiently low energy when ionized, it typically becomes confined within the core by the combination of the magnetic field of the cathodic magnet (of minor effect) and the negative space charge of the cathode (of major effect). In fact, high densities (e.g., 10²⁰ particles per m³) of the confined populations of such low-energy ions may be achieved because the space charge of the confined ions is neutralized by the space charge of the confined electrons.

The confined population of low-energy ions may, in some embodiments, dramatically increase the rate of fusion reactions by confining a high density of “fusion targets” in a volume where they can be struck by the energetic ion beams recirculating through the core of the device. This rate of fusion reactions from collisions between the energetic ions in the beams and low-energy ions confined in the core can, in some cases, greatly exceed the rate of fusion reactions occurring between energetic ions within the beams. The beam/trapped-plasma fusion rate scales linearly with beam current, while beam/beam fusion scales with the square of the beam current. Thus, the fusion output of devices that are dominated by the beam/plasma fusion reactions generally scale substantially linearly with beam current.

Fusion reactions may serve to produce fast neutrons or ions, which are useful for a variety of industrial, military, medical, and research applications. For many such applications, the utility of the device, used as a fast neutron or ion generator, increases with the number of particles generated per unit time and/or with the energy efficiency of particle generation. In some embodiments, the recirculating current may achieve values on the order of or exceeding 100 times the injected ion current. If the convergence of the ions in these embodiments can be focused to a sufficiently small core region, or a low-temperature ion population of sufficient density is provided in the core region to provide a fusion target, then it may even be possible to achieve net power from the reactor because the fusion reactions will liberate more energy than that required to cause them to occur.

The term “recirculation,” as used herein, denotes the existence of ion trajectories that repeatedly take ions in and out of the magnet without intercepting solid structures. Typically, the trajectories are each oriented about a single axis of the polyhedral symmetry of the magnet, where the ion starts with low energy outside the magnet and is accelerated toward the magnet, passes through the interior region of the magnet, exits out the opposite side of the magnet, and decelerates as it moves away from the magnet until its radial component of velocity relative to the center of the magnet drops to zero, at which point it begins to accelerate toward the magnet again and repeats the recirculation cycle. Such recirculating trajectories through the magnet are unlikely to be identical orbit to orbit, but as long as an ion repeatedly passes through the magnet without intercepting solid structures (e.g., the repellers or the ion deselectors), the ion is said to be “trapped” on a “stable” orbit.

In general, the electrostatic configuration of the system including the magnet, repellers, ion source, reflectors and ion deselector may be sufficient to trap ions in stable orbits without activating the magnetic elements of the magnet (i.e., without trapping any electrons in the magnet). Such electrostatic ion traps have been developed by various researchers in the past, and techniques for designing a stable electrostatic ion trapping system are described in the scientific literature, and therefore known to those of ordinary skill in the art. An aspect of certain embodiments of this invention relates to the combination of the ion trap with a magnetic trap for electrons and/or electron-ion plasma in the center of the trap. Another aspect concerns the combination of an electrostatic ion trap with an integrated ion source to continually input ions into the trap, and thereby to make up for those ions that may be expelled from the trap through scattering, charge exchange, or other factors.

The following sections describe in more detail various features and components of fusion devices such as the one illustrated in FIGS. 3 and 4, as well as additional features and alternative embodiments.

### 2. Magnet Topologies and Geometries

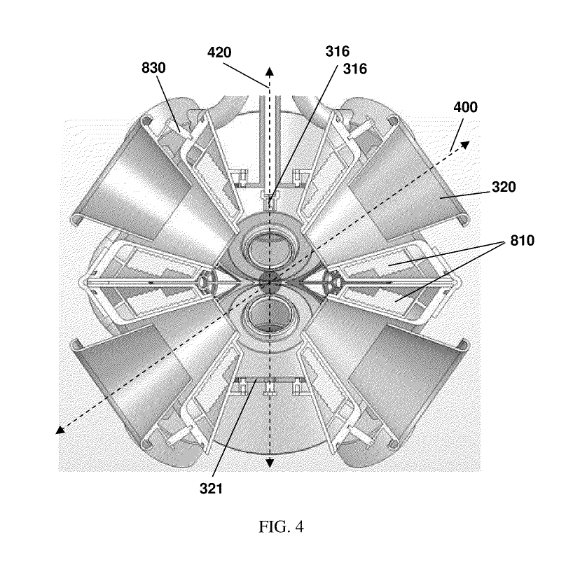

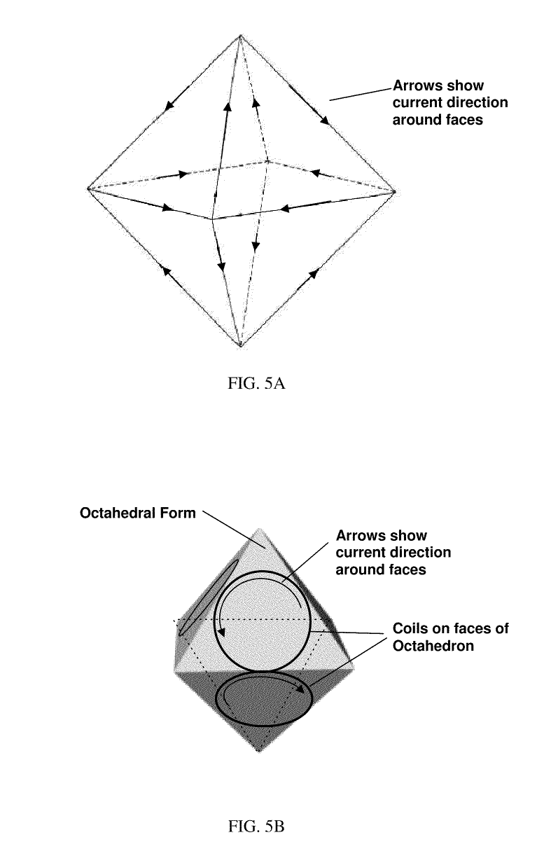

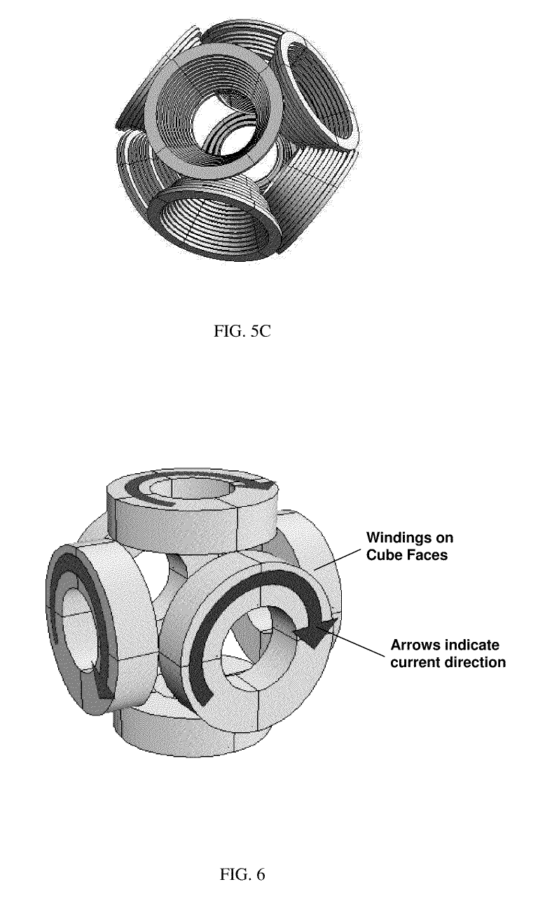

Suitable magnets for use in fusion-generating devices in accordance with embodiments of this invention generally have a polyhedral topology. More specifically, they typically form uniform polyhedra, i.e., vertex-transitive polyhedra whose faces are all regular polygons. For example, in certain embodiments, the magnet forms an octahedron. To form a multi-poled magnetic field, magnetic elements may be arranged on the edges of the polyhedron, as shown in FIG. 5A. The magnetic elements need, however, not be straight, but may be curved, as long as the magnetic fields that are created point in and out of the interior volume of the cathodic magnet in such a fashion as to create a multi-poled field. Therefore, the physical arrangement of the magnetic elements about the polyhedral faces does not need to have the sharp corners at the vertices of the underlying idealized polyhedral shape of the magnet. Instead, the magnetic elements of the face may be rounded as the magnetic structures approach the vertices of the polyhedron. In fact, the magnetic structures may consist of completely rounded structures that are inscribed within the idealized polyhedral faces and only contact the magnetic structures of the adjacent faces at a tangency point along the shared edge of the face. For example, as indicated in FIG. 5B, electromagnetic coils may be placed and centered on the faces of the polyhedron. In general, the coils (or other magnetic elements) have a radial extension or depth, and may contact the magnetic elements of adjacent faces along a line or surface. As illustrated in FIG. 5C, their windings may lie in planes of nested polyhedra with a common center (thus forming the envelopes of truncated cones or cylinders).

The octahedron is an example of a platonic body, i.e., a polyhedron whose faces are all of equal shape and size, with equal angles between them. The octahedron provides the advantage of having wide faces with respect to the internal cavity area of the structure. In various embodiments, the magnet has a non-platonic topology. In fact, the octahedron is the only platonic body suitable for generating multi-poled fields. Any polyhedral magnet capable of producing a multi-poled field that does not have an octahedral topology is not platonic and, thus, has differences in the shapes of the magnet openings from one opening to another. Consequently, it may experience variations in magnetic field strength from one opening to the next. This effect may be mitigated by shaping the windings in such a way as to equalize the combined area for the faces of outgoing flux to the combined area for the faces of incoming flux. This may be achieved in certain embodiments by shaping the windings on the faces of the polyhedra in a configuration somewhere between an inscribed circle on the polyhedral face and the edges of the polyhedral face.

As the magnetic elements about the faces of the magnet become more rounded, they may open up a new face at the vertices. For example, the truncated cube configuration is created by having rounded magnetic elements (e.g., round tubes, squares tubes with rounded corners, conical tubes, etc.) distributed about and inscribed within the faces of a cube, as illustrated in FIG. 6. When all of the magnetic elements are arranged in this configuration and with identical polarity, i.e., the magnetic field lines at the center of each magnetic element all point towards the center of the device (as shown in FIG. 6) or all point away from the center of the device, then the magnetic field lines exit (or enter, respectively) the magnet through the space created by the rounding of the magnetic elements near the vertices of the cube.

The openings at the vertices created by the rounding of the magnetic elements need not always have substantial magnetic flux pass through. By way of example, one can consider an array of conical electromagnets aligned on the faces of an octahedron, as illustrated in FIG. 5C. If the polarities of the magnets are alternating (i.e., the polarity of any magnet is the opposite of the polarity of the magnets on each adjacent face of the octahedron), then the new faces created at the vertices by the rounding of the magnetic elements have relatively little magnet flux pass through, as magnetic field nulls tend to extend from the center of the magnet to the interstitial faces at the vertices. However, if the conical coils are all of identical polarity, all of the flux pass out of (or into) the six faces created by the rounding of the coils. In effect, this creates the magnetic topology of a truncated cube, which is the next-higher-order multiple geometry and is the same magnetic topology as that created by the electromagnets shown in FIG. 6.

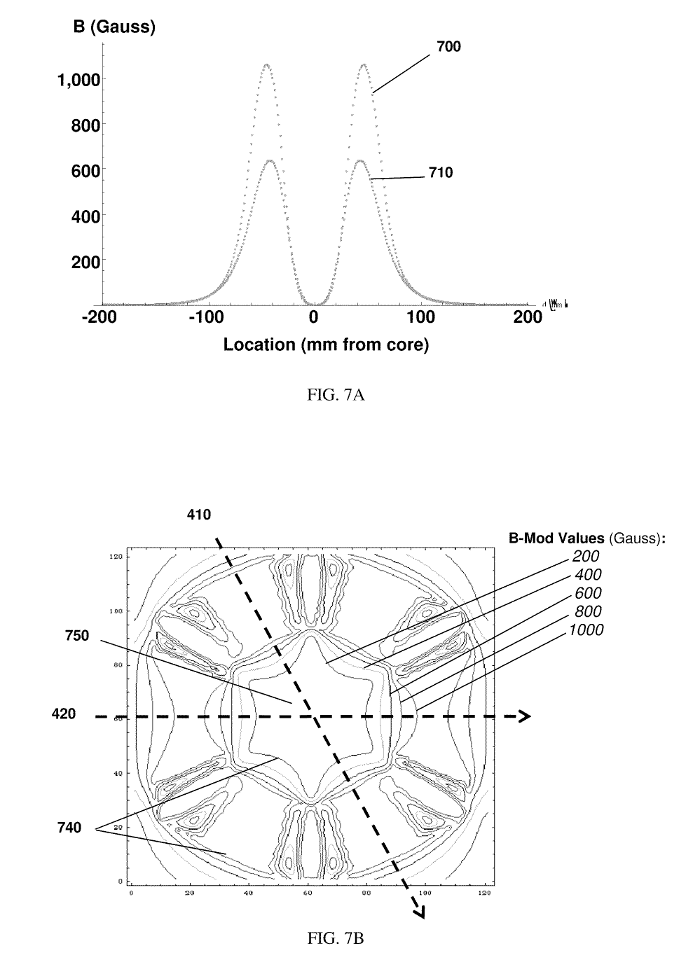

FIG. 7A shows a graph of the absolute value of the magnetic field 700 in a cathodic magnet with truncated-cube topology as a function of position along an axis extending through a pair of opposing faces of the conical magnets, as shown FIG. 4 by the dotted line 400. As described above, this is the axis along which ions are injected by the ion generators 314. As can be seen, the variation in magnetic field strength is roughly parabolic for the interior region of the cathodic magnet (i.e., from approximately −40 mm to +40 mm from the core). The absolute value of the field 710 along axes corresponding to the faces of the cube in the truncated cube configuration, which are located between the conical magnets (shown as the dotted line 420 in FIG. 4), is weaker, but also exhibits a roughly parabolic profile over the same region. The magnetic field strength decays to zero near the center of the structure in both cases. In magnetic confinement, particles tend to drift towards regions of weaker magnetic field. This kind of magnetic geometry is magneto-hydrodynamically (MHD) stable for all plasmas.

The MHD stability due to the magnetic field geometry is also illustrated by lines of constant magnetic field strength, as plotted in FIG. 7B in a representation viewed from the perspective of a cross-section of the cathodic magnet taken through a plane including both an ion beam axis 410 and the electron emitter axis 420. The lines enclosing the central area of the structure are the lines of constant magnetic field strength 740. The magnetic field is most intense within the conical magnets, and decreases in intensity toward the center of the structure or toward the outside of the structure. Thus, the magnet interior region or central core 750 is comprised of a magnetic “well” in which magnetic field lines are everywhere convex, which is very well suited for confining charged particles.

In addition to the underlying geometric body, an important aspect of the magnet topology is its radial-to-azimuthal aspect ratio. For example, one can consider the cross-section of the windings, when sectioned by the plane on which lies the ion axis of a given polyhedral face and where such plane is perpendicular to the edge of the polyhedral face. In this configuration, the radial dimension of such a cross-section is the difference between the maximal and minimal extent of the cross-section when measured radially from the center of the magnet. The azimuthal dimension is the width of the cross-section (again maximal extent) as measured in a direction perpendicular from an axis extending from the center of the magnet and passing through the geometric center of the winding cross section. Although not necessary for successful operation of the magnet, a high radial-to-azimuthal aspect ratio is advantageous for creating strong magnetic fields without reducing the volume available to ion flow (i.e., the transparency of the magnet). By extending the magnet in the radial direction for a for a given current density, a larger magnetic field can be created without increasing the occlusion of the polyhedral faces with tangible magnet structures. As a result, there is a lower probability of ions impacting the magnet structure and producing heat (which, in turn, would reduce efficiency).

An additional advantage of a radially deep cathodic magnet structure is that the electrostatic potential is more deeply established through the structural openings in the radial direction. This is important to provide a high acceleration to ions, and, in the case of electron repellers, a high electrostatic barrier to electrons found within the device. For example, the electric potential resultant from the surfaces of a long, negatively biased tube is more negative in the center of such a tube, as compared to the potential of a similarly biased short tube or ring.

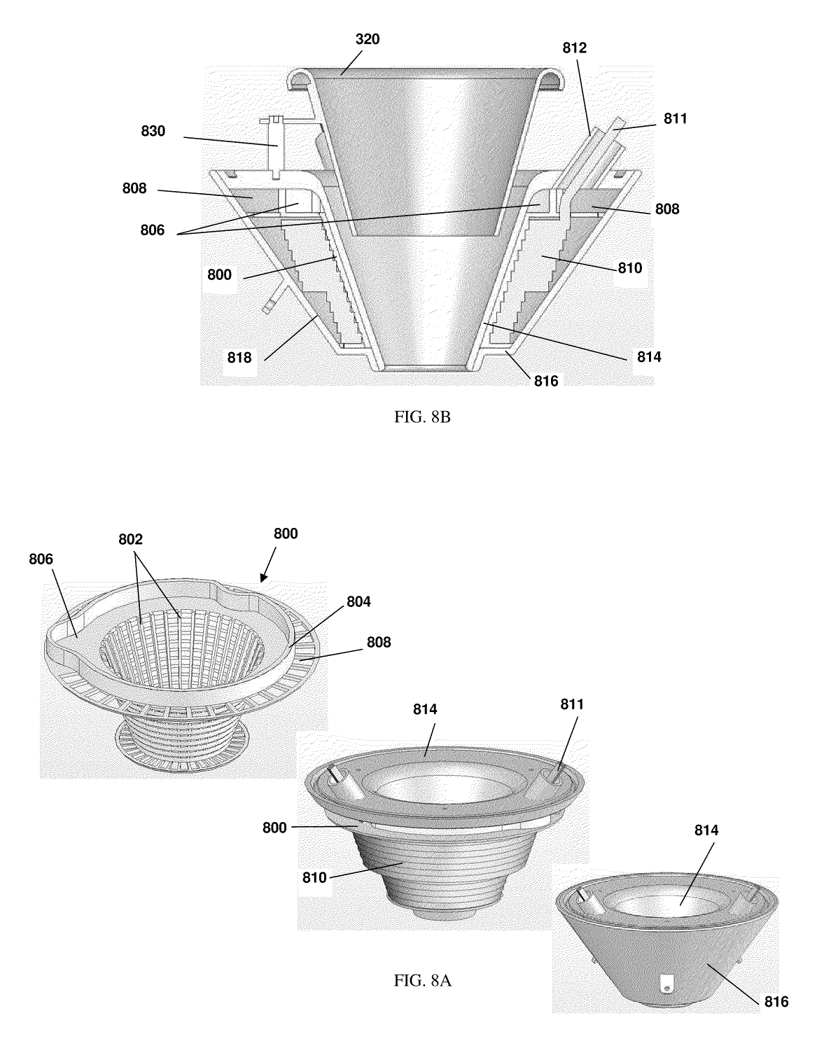

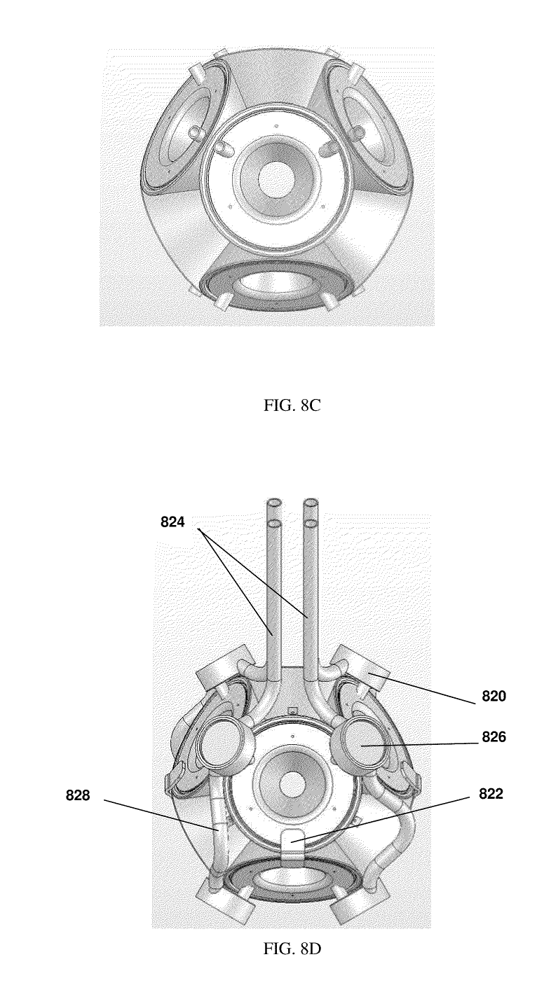

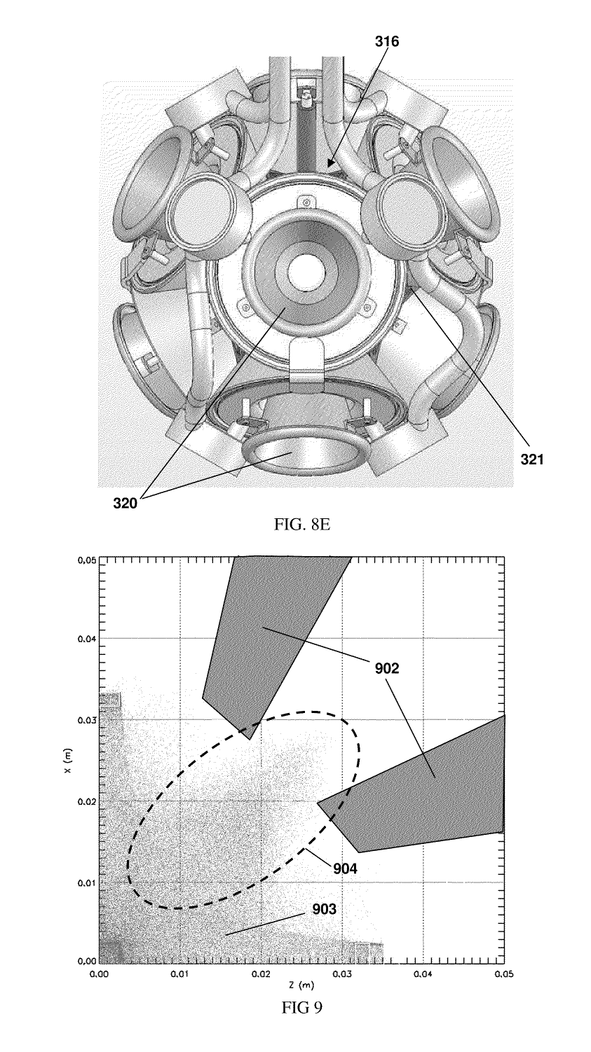

When building radially deep magnetic structures, it may be advantageous to give the winding a wedge-shaped cross section, i.e., to make their azimuthal thickness smaller in the sections closer to the core and large further from the core. Such shaping allows for inclusion of a larger volume for magnetic windings without any reduction to the open angle available for ion trajectories. FIG. 8B illustrates a conical magnet with a high radial-to-azimuthal aspect ratio and such a substantially wedge-shaped cross-section.

### 3. Magnet Construction

FIGS. 8A-8D illustrate an exemplary detailed construction technique for a cathodic magnet in accordance with various embodiments of the invention. In this example, the magnet is configured of eight conical electromagnetic coils in an octahedral arrangement, as shown in FIG. 8C. These coils are actively cooled with an insulating fluid coolant, such as deionized water. As mentioned previously, such an octahedral arrangement of conical magnets can be wired to achieve either an octahedral or truncated-cube magnetic topology. As shown, the eight conical magnets are arrayed about the center of the magnet. The conical angle of the outer surface of the magnets is such that each cone is approximately tangential to three other cones. The outer shells of the conical magnets themselves are formed from a material selected for vacuum compatibility, manufacturability, and suitable magnetic permeability and secondary emission coefficients. Such parts may also be coated by other materials to improve function. For example, they may be coated with carbon to reduce metal sputtering when they are impacted by energetic particles.

FIGS. 8A and 8B show the construction of a single conical magnet. FIG. 8B shows the cross-section of the conical magnet. The conical magnet starts with winding carrier 800. This part is made from a suitable engineering plastic with sufficient tolerance to high temperature and to the cooling fluid (e.g., ABS, PPS, etc.). A series of raised segments 802 may be provided on the surfaces of the winding carrier to provide coolant passages along the outer surfaces of the inner shell of the conical magnet 814 in order to ensure uniform coolant flow throughout the conical magnet structure. In addition, a separator wall 804 may be added to the winding carrier to create a separate input plenum 806 and output plenum 808, and thereby direct the coolant along specific paths through the conical magnet in order to assure that all portions of the windings 810 within the conical magnet are sufficiently cooled.

The conductive windings 810 are typically insulated wire such as insulated copper magnet wire. In certain embodiments, however, the windings may be made of a superconducting material, which could significantly increase the efficacy of the electromagnet. The conductive windings 810 are wrapped about the winding carrier 800 with interconnection leads 811 placed inside the coolant connecting tubes 812. The winding carrier 800 is slipped over the inner shell 814, either before or after winding. To assure a sufficiently fluid-tight seal between the input and output plenums, a sealant (such at RTV silicone) may be applied to appropriate surfaces of the winding carrier 800 immediately prior to assembly with the inner shell 814. Once assembled, the outer shell 816 may be slipped on and welded (or otherwise sealed) to the inner shell 814. Those skilled in the art will recognize that such seals need not be welds. For example, the inner and outer cones may, instead, be sealed with epoxy, or mechanically held together with an arrangement of fasteners and elastomeric seals, as long as the inside is pressure-tight (e.g., sufficiently well sealed to prevent leakage of coolant into the high vacuum environment outside the conical magnet, such that the requisite high-vacuum can be readily maintained) and can withstand the pressure imparted by fluid coolant that, in operation, is forced through the interior passages of the structure in order to remove the excess heat from the electromagnet windings. The windings may nearly fill the space between the outer surface of the winding carrier 800 and the inner surface 818 of the outer cone. A small space may be left between the windings and the inner surface of the outer cone in order to provide a passage for coolant to travel and allow for manufacturing tolerance stack-up. Of course, to aid in fabrication, each of the components described above may consist of sub-components that are assembled into said components prior to assembly of the conical magnet element.

The design of the conical magnet is such as to produce a cathodic magnet that has a high radial-to-azimuthal aspect ratio. Unlike various prior-art IEC devices, the illustrated construction favors the formation of winding loops that are stacked radially with respect to each other. For example, the ratio of the number of windings stacked in the radial direction to the number of windings stacked laterally (i.e., between the inner and outer shell) may be greater than 1:1, greater than 3:2, greater than 2:1, or greater than 3:1, depending on specific design goals.

FIG. 8B shows a cross-section of the assembled conical magnet. Note that the illustrated windings are square windings, and the separations between individual windings are not shown but can be inferred from the stair-step contours of the windings. Furthermore, the windings shown are not necessarily to scale, and the number of windings has been selected arbitrarily for purposes of illustration only. In an actual construction, both the gauge of the wire and the number of windings would be selected according to design requirements.

Once eight conical magnets have been fabricated, they may be arranged in the octahedral configuration shown in FIG. 8C. As shown in FIG. 8D, the eight coils may be rigidly interconnected by welding their coolant connecting tubes 812 into junction cans 820 or connecting them with brackets 822 or through some other suitable means. During assembly, the junction cans 820 are connected by interconnection tube 828. Some, but not necessarily all, of the tubes may also contain one or more conductors for electrical interconnection of the magnets. Stalk tubes 824 may also be welded into the junction cans 820. The junction cans 820 may also provide a volume in which multiple conductors from the magnet may be connected via some appropriate technique such as soldering, welding, or mechanical crimping. Once such connections are complete, cover discs 826 may be welded onto the junction cans to seal them. As a final step, electron repellers 320, 321, electron absorbers 324, and emitters 316 may be attached to the magnet as shown in FIG. 8E. Such attachments may include insulating stand-offs 830 (shown in FIG. 8B) so that the repellers may be held at a potential different than the magnet potential. The nature of the stand-off and the separation distance is, generally, a function of the difference in voltage between the respective components. For example, a 5 mm alumina stand-off may be used between an electron repeller and the magnet 304 if the potential difference between the two is 10 kV or less.

In some embodiments, some or all of the windings are wired in series in order to assure exactly equal current in each winding in the series array. In some embodiments, some or all of the windings are plumbed such that fluid coolant is fed to coils in parallel in order to avoid having some coils run hotter than others due to feeding with pre-warmed coolant. Those knowledgeable in the art will recognize that the order of assembly may be modified to improve manufacturability; such modifications include, but are not limited to, grouping the various components into subassemblies which are assembled first. The order of assembly noted above is not intended to be limiting.

### 4. Electron Profile and Gabor Lenses

In various embodiments, the magnetic configuration provides for the creation of “Gabor lenses” at or near the center of the openings of the cathodic magnet. These lenses consist essentially of regions of negative space charge that extend from the center of the device toward the center of the faces of the cathodic magnet and, in some embodiments, well past the inner diameter of the magnet. The electrons forming the lenses are generally well-confined by the magnetic field, which forms a magnetic mirror at or near the center of the face of the magnet, and by the electron repellers, if present. The interaction of the magnetic field with the space charge of the electrons may result in roughly conical shaped regions, formed near or through the faces of the magnet and centered on the polyhedral axes, as shown in FIG. 9. In FIG. 9, the output of a PIC-type 3D computational simulation of the electron confinement in an exemplary truncated-cube magnetic topology is plotted. Only a single octant of the region is shown. The origin of the coordinate system represents the center of the polyhedral magnet. The shaded regions 902 indicate cross sections of the magnet 302 structure. As can be seen, the confined electron population 903 has a local density maximum in the core, and extends out of the core zone and all the way into a polyhedral face (interior region of conical magnet), where it forms a Gabor lens, indicated by dotted ellipse 904.

The electrons that form these lenses may exert an electrostatic force on at least some of the ions traveling toward the center of the magnet, so that the ion trajectories pass closer to the geometric center of the cathodic magnet than they would have, had the lens not existed. The electrons may also exert an electrostatic force on at least some of the ions traveling away from the center of the magnet so that their trajectories are redirected to trajectories that are less likely to impact the magnet.

In various embodiments, the Gabor lenses are shaped to control the ion trajectories, which, in turn, facilitates improving the overall performance of the fusion-generating device. Control of the shape of the lens may involve a number of factors. Generally, it implies control of the profile of the component of electrostatic potential that is perpendicular to the axis of the lens (which axis also passes through the center of the device and the center of the polyhedral face in which the lens is situated). It is this component of the electrostatic potential that has the effect of creating a restoring force on ions that are traveling off the axis of the lens. In cases where the magnet element at a polyhedral face is an inscribed body of revolution (e.g., a cone envelope), this potential profile is a function of the distance along the lens axis from the center of the magnet and the perpendicular distance away from the lens axis. In cases where the magnet element is something other that a body of revolution (e.g., a shape that more exactly follows the polygonal shape on the idealized polygonal face of the polyhedron), the potential is further a function of an angular orientation relative to the face. For purposes of discussion, only bodies of revolution will be described below, but those knowledgeable in the art will recognize that similar arguments can be made for non-rotationally-symmetric lenses, with the added complexity of accounting for aberrations due to lack of symmetry.

Presuming a perfectly collimated ion beam entering the face of the magnet, the ideal lens has a potential distribution that asymptotically approaches a parabolic distribution as one moves perpendicularly away from the lens axis, resulting in all of the ions being focused to a single point. Potential distributions other than parabolic ones also have a focusing effect, but spread the focal region along the axis of the lens. In any case, the focal length of the lens is a function of the length of the lens, the radius of the lens, the center electrostatic potential of the lens, and the ion beam energy. The focal length is a function of the length of the lens because longer lenses exert more impulse on a given ion (the ion spends more time being acted upon by the lens) and thus have shorter focal lengths. The focal length is also a function of the strength of the electrostatic field as one moves perpendicularly away from the lens axis. The force exerted by the lens on an ion is a function of the component of the electrostatic field which is perpendicular to the axis of the lens. The electrostatic field is the gradient of the potential field of the lens, and the focusing component of the field is the component perpendicular to the axis of the lens. In effect, higher potentials yield larger gradients and, thus, stronger electrostatic fields. In turn, higher electrostatic fields perpendicular to the axis of the lens generally result in a stronger restoring force on the ion and, thus, in a shorter overall focal length for the lens. In order to maximize the fusion power of certain embodiments where a substantial portion of the fusion reactions are beam/beam reactions (vs. beam/plasma reactions), it is generally desirable to focus the ion beam to as small a diameter as possible at the core of the magnet (since beam/beam fusion power is inversely proportional to the convergence radius of the ions). Therefore, a preferred design puts the focal point of the lens as close as possible to the center of the device.

The focusing characteristics of the lens may be optimized by controlling the electron density distribution within the lens region. The depth of the potential well generated by the electrons may be controlled via the energy at which electrons are injected into the confinement region, which is in turn determined by the electrical bias of the electron emitters with respect to the cathodic magnet. In order to keep the ion paths open to prevent interference with the ion beams, elements used for the injection and control of electrons within the magnet are preferably placed away from the beam paths. By various mechanisms, the electrons may travel from the emission elements and take up position at the core magnet and in the lens regions. These mechanisms may be based on approximately equipotential surfaces that connect every face in the multipole to every other face, and along which the electrons may travel. An infinite number of such surfaces are nested inside the other. These surfaces surround and do not intersect the symmetry axes of the polyhedron. In fact, the axes may be considered degenerate, one-dimensional surfaces. The surfaces allow ready migration of electrons along each surface (which renders them equipotential surfaces), but retard migration between adjacent surfaces.

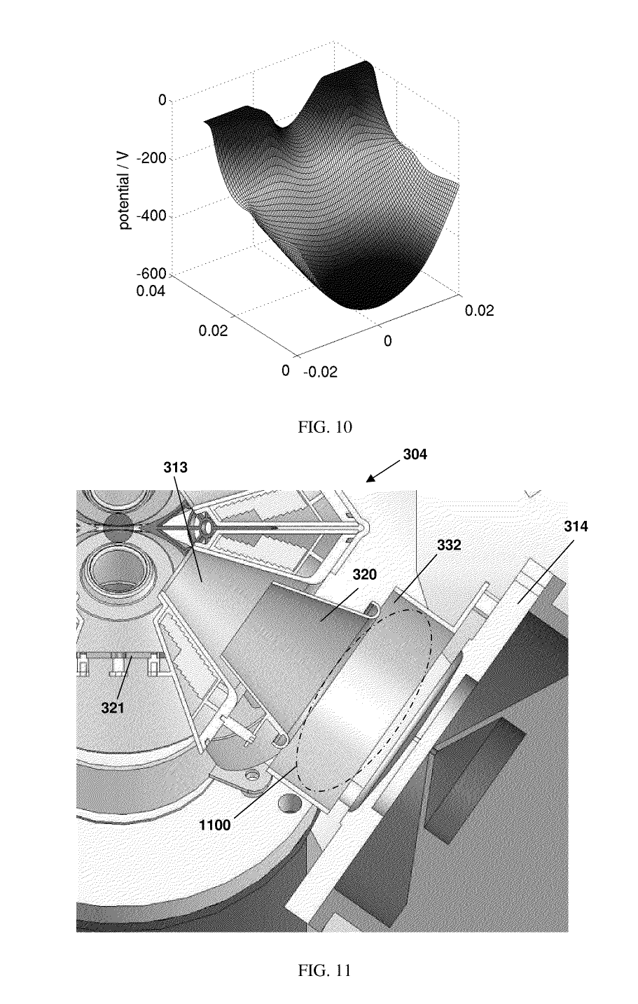

Computational simulations have shown that, when electrons are fed into the inner-most flux surfaces (i.e., those flux surfaces closest to the symmetry axes), a portion of the electrons naturally diffuses to the outer surfaces (i.e., those equipotential surfaces further away from the symmetry axes), creating a potential distribution. This distribution is (approximately) parabolic (at least in the absence of an ion beam), and thus highly suitable for creation of the desired space charge (i.e., Gabor) lenses about the axes of the faces. In practice, electrons are generally generated over a finite area, and hence have access to the true three-dimensional equipotential surfaces proximate to the one-dimensional symmetry axes. Computational simulations have shown that, as long as the electrons are introduced to those equipotential surfaces closest to the axes, diffusion of electrons from the equipotential surfaces proximate to the symmetry axes toward those surfaces further away from the symmetry axes yields the desired parabolic potential distribution to close approximation. FIG. 10 provides an example output of such a computational simulation, which shows the potential as function of the distance along a beam axis from the core and perpendicular distance from the beam axis. Because the equipotential surfaces connect to every face of the polyhedral magnet, a single electron source may control the electron population distribution in all of the faces of a polyhedral magnet of arbitrary order. In some embodiments, it may be desirable to use a symmetric array of emitters distributed about the magnet in order to assure that the respective lens performances are approximately equal among the various polyhedral faces.

Those skilled in the art will recognize that electrons may be introduced to the interior of the magnet through a wide variety of methods. These methods include ionization of neutral gasses, secondary emission from the inner surfaces of the cathodic magnet, and the use of dedicated electron sources. The use of dedicated electron sources (herein also referred to as “emitters”) provides a practical means to control the amount, location, and energy of electrons introduced to the confinement region of the magnet. Thus, it facilitates the delivery of electrons to the surfaces closest to the symmetry axes of the faces, which, in turn, tends to result in a desirably parabolic distribution.

Various embodiments use one of two approaches to inject electrons into a surface close to the symmetry axes. The first approach involves utilizing field nulls that may be present in some multipole topologies and which extend toward the vertices of the polyhedral faces. An electron emitter may be placed at one of these vertices, and may be oriented such that it emits along the field null toward the center of the magnet. When an electron arrives near the center of the magnet, it is free to travel along the equipotential surfaces closest to the axes of the polyhedral faces and thereby to populate the lenses with electrons and to set up the desired parabolic potential distribution. However, the field configuration around such field nulls is a quadrapole field for multipole magnets based on polyhedra having four edges intersect at a vertex, and quadrapole fields tend to be strongly defocusing (at least in one dimension) for charged particle beams. For higher-order multipole magnets based on polyhedra with a greater number of edges intersecting at a vertex, the fields are more complex (e.g., hexapole, octapole, etc.), but may still defocus electrons beams emanating from the emitters. Computational simulations have shown that emission of electrons in such quadrapole fields may be less effective because electrons are quickly turned onto trajectories that take them away from the center of the magnet (thus also away from the equipotential surfaces closest to the axes of the polyhedral faces). Thus, even though Gabor lenses are formed, they may, in some cases, not have optimal strength and profile. On the other hand, the use of field nulls for electron injection advantageously leaves the symmetry axes through the faces of the polyhedral magnet available for recirculating ion beams, which may outweigh the suboptimal Gabor lens profiles.

An alternative approach to deliver electrons near the center of the magnet involves setting aside one or more congruent sets of opposite faces of the polyhedral magnet for ion beams, while using one or more of the remaining faces for the electron emitters. For example, the truncated-cube configuration may be used with four ion beams traveling through the faces corresponding to the truncated corners of the cube (eight faces in total, as each beam travels through two faces on opposite sides of the center of the magnet), and up to six (but at as few as one) of the six faces corresponding to the faces of the cube prior to truncation hosting the electron emitter(s). As with all polyhedral multipoles, all of the faces of the polyhedral magnetic topology (in this case, a truncated cube) are interconnected by the equipotential surfaces described above. This configuration allows the emitter to emit electrons directly onto those surfaces nearest to the axes of the faces, and thereby set up the desirable parabolic potential distribution. This configuration also allows for the direct control of the potential distribution. Multiple emitters may be arranged such that the potential on multiple equipotential surfaces may be independently controlled. Thus, the use of multiple emitters facilitates creating and actively controlling a potential distribution of arbitrary profile. This approach may be applied to polyhedra of higher order as well. Further, as indicated previously, the control of the potential distribution may, in some embodiments, be accomplished using electron absorbers (such as, e.g., conductors capable of accepting electrons and held a specific potential) instead of or in addition to emitters.

### 5. Electron Repeller

In certain embodiments, the fusion device includes one or more negatively charged repeller electrodes (or simple “repellers”), situated about the faces of the magnet, to further confine the electrons within the hollow interior region of the cathodic magnet. Although the electrons are substantially confined by the magnetic field, some electrons may come to occupy regions in phase space where they are able to escape the magnetic confinement. In effect, they may pass through the magnetic mirrors at the polyhedral faces because they either have gained sufficient energy to overcome the magnetic field (through heating, collisions, etc.) or are on trajectories that are sufficiently close to the axis of the mirror that they do not cross field lines that would otherwise steer them back toward the center. To counter this effect, a repeller electrode may be placed such that to escape the magnet, electrons must not only pass through the magnetic mirror, but must also climb up a potential hill created by the repeller electrode. This may be achieved by biasing the repeller electrode negatively with respect to the magnet. An example of such a repeller electrode 320 is shown in cross section diagram of the conical magnet in FIG. 8B.

In some embodiments, the bias of the repeller relative to the magnet is a fraction (e.g., <10%) of the bias between the magnet and the origination potential of the ions. When the repeller is significantly more negative than the magnet, ions experience a significant potential hill upon passing the repeller towards the center of the magnet. However, this effect is generally compensated by the higher energy that the electrons acquire between the anode and the repeller due to the more strongly negative repeller potential. This negative potential may also aid to accelerate the ions from the ion source (which is especially important when the ion source is near the Child Langmuir limit) and to electrostatically focus the ion beams at the core. Preferably, the repellers are configured in such a way that they have high transparency to the ion beam while, at the same time, being substantial enough to create sufficient electrostatic potential at the center of the polyhedral faces to repel a substantial number of those electrons capable (due their position in phase space) of penetrating the magnetic mirror.

In one embodiment (shown, for example, in FIG. 8B), such repellers substantially take the form of conical tubes located symmetrically around the axis of a polyhedral face. The inside surface of the repeller is substantially aligned with the center of the magnet and is therefore substantially parallel to the ion trajectories passing through the polyhedral face. The conical tubes may be of sufficient length to substantially reduce the droop in electrostatic vacuum potential on their symmetry axis (e.g., the diameter-to-length ratio of the tubes may be equal to or greater than 1). In other embodiments, the electron repeller electrode may be located in a region where ions do not travel. In these cases, these alternate repeller electrodes may approximate a planer shape that fills the extent of an open angle on the magnet. For example, the alternate electron repeller electrode 321 shown on FIGS. 3B, 3D, and 4 prevents a portion of electrons from escaping out of the magnet through a field null or magnetic mirror for octahedral and truncated cube magnetic topologies, respectively.

Those knowledgeable in the art will recognize that such repellers need not be physically attached to the magnet, as long as they are sufficiently near the open faces of the magnet through which electrons might escape. The repellers may be considered part of the magnet assembly 304, as this is a convenient method to fabricate such magnet/repeller assemblies.

### 6. Ion Deselector

In various embodiments, the fusion device includes one or more ion “deselectors” subsystems that aid in increasing the efficiency of device operation. Such deselectors may be placed near the birthplace of ions (i.e., near the ion sources), in regions that defocused ion paths most likely lead to. The function of the deselector subsystem is largely independent of the magnet configuration. A schematic drawing of a deselector 332 is incorporated in FIG. 3B and shown in cross-section in FIG. 11. While both figures show conical magnets, the deselector is generally effective with any of the described magnet configurations, provided it is disposed about a polyhedral axis. A number of deselectors 332 may be located in regions near the anode (e.g., the vacuum chamber wall 302, the ion source 314, or the ion reflector 328) that are “off-axis” with respect to the ion channels. These regions may be biased with the appropriate voltage to allow the ions to impact upon a solid surface at relatively low energy (e.g., <10,000 eV).

The operation of the deselectors 332 is as follows: Ions that escape the cathodic magnet and travel toward the chamber wall progress toward either an ion reflector (328 or 302) or an ion source 314. The deselector electrode is disposed about the periphery of the ion turn-around region 1100 by the anode (approximately indicated by the dotted ellipse in FIG. 11). It is typically charged to a potential which is slightly negative with respect to the chamber wall (i.e., the system anode). A positively charged ion approaching the turn-around region 1100 on a favorable (on-axis) trajectory will be repelled by the ion source 314 or ion reflector 328 and be reflected back toward the cathodic magnet 304 on a trajectory favorable for re-penetration of the magnetic field and avoidance of a collision with the magnet structure. If an ion approaches off-axis on a less favorable trajectory (e.g., with a substantial azimuthal velocity component), it will be attracted to the peripheral deselector screen 332 because of the negative potential of that electrode. Upon impact, the ion immediately recombines with an electron, forms a neutral molecule, and is pumped out of the system by standard means. In this manner, the energy confinement time of the machine can be kept large, while the ion/particle confinement time may be much shorter. Each ion returns most of its energy to the apparatus as it climbs the potential hill away from the cathodic magnet 304, and the actual work performed by the power supply of the deselector 334 is small. In addition, the cooling requirements upon the cathodic magnet 304 are reduced because fewer ions actually strike the magnet surface. This is especially important if the cathodic magnet 304 is constructed from cryogenically cooled superconducting material.

With regard to the processes occurring within the cathodic magnet 304, high-energy ions converge to the central core, with a core radius at least in part determined by the angular momentum of the ion beams. The purveyance of the ion source 314, ion reflector 328 and the potential of the ion deselector electrode 332 may be adjusted to minimize the convergent core size. In other words, the location and bias of the ion deselector electrode 332 can also serve to adjust the electrostatic properties of the system so that the beam may be better focused at the core, or that ions are otherwise confined within the system for a longer period of time (higher number of average recirculations) and/or at higher densities (higher current per beam).

### 7. Additional Improvements

There are additional improvements or effects that may (but need not) be implemented or exploited to further increase the efficiency of fusion-generating devices in accordance with various embodiments. One of these improvements involves the use of double or triple potential wells, caused by the inertia of electrons and ions, and their interaction via Coulombic forces. It is known in the art that alternating potentials may be established in a spherical IEC device by adjusting the ion and electron currents and energies such that spherical virtual electrodes are formed by regions of space charge of one polarity or another. This may be briefly explained as follows: If ions are injected in spherical geometry, they will converge and form a region of positive space charge. With sufficient current, this region may become so dense that the self-potential of the ion beam will repel any further ions. This dense charge region is called a virtual anode. Ions approaching the virtual anode are slowed to zero velocity when they give up all their kinetic energy to the potential energy of the space charge. If electrons are then injected at some other outer radius such that they are accelerated toward the positive virtual anode, they will “overshoot” said region because of their inertia and begin to form a region of negative space charge further inside at a smaller radius. For the electrons, in the same manner as for the ions, this effect can be so pronounced as to cause a virtual cathode, a region of space charge that forms a potential of the same magnitude as the virtual anode, but of opposite sign, provided that the right magnitudes of current and acceleration are employed.

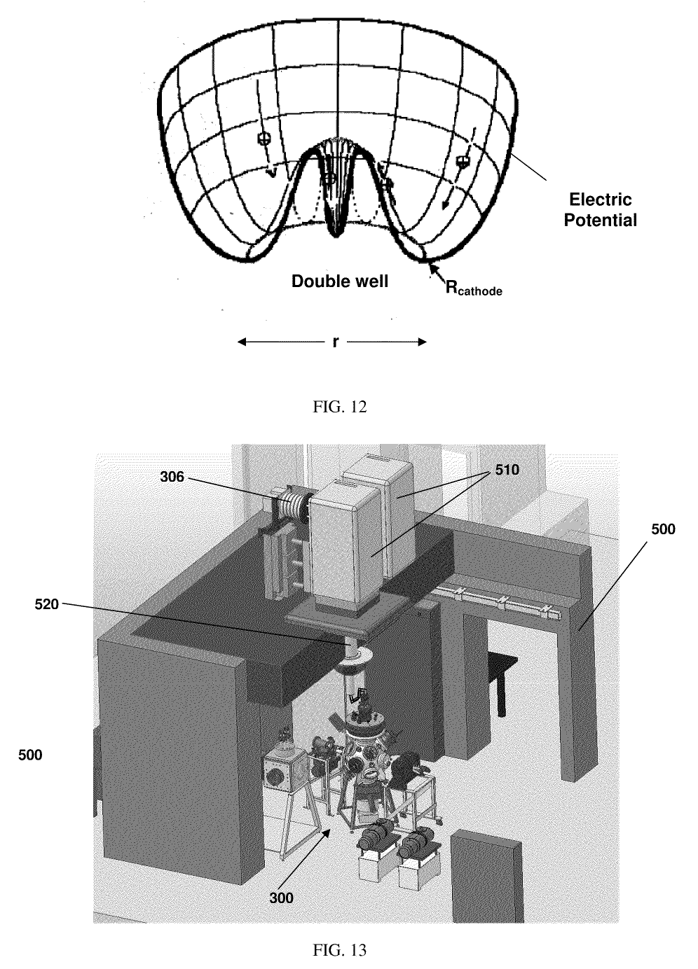

FIG. 12 is a graphical representation of the electric charge potential as a function of the distance from the center of a spherical geometry. The aforementioned overshoot or “sling shot” effect may thus give rise to multiple, alternating layers of virtual electrodes, caused solely through the interaction of the spherical beams of electrons and ions. This phenomenon was first predicted in the 1950s and has since been confirmed through experiments in laboratories and through numerical and analytic calculations.

While the formation of virtual electrodes occurs for certain regimes in parameter space with the purely electrostatic IEC concept, preferred embodiments of the present invention facilitates the effect much more readily by virtue of the magnetic confinement of the electrons, and manipulation of electron orbits. In the cathodic magnet 304, a negative potential at the center may be established. This potential arises from the emission of electrons and the subsequent confinement of electrons about the polyhedral axes, which forms a quasi-spherical virtual cathode about the center of the magnet. Ions (with a positive charge) rush in and form a virtual anode, but not necessarily of the same magnitude as their injection energy. Nevertheless, in some embodiments, a spherical shell in which the electric field is zero may form due to the convergence of ions. Electrons from the outer real cathode at the magnetic reflection boundary may oscillate through this anode and form a virtual cathode in the center of the device. The mobility of electrons is largely unaffected by the magnetic fields near the center of the device because the requisite multi-poled magnetic fields are such as to cause the magnetic field to approach zero near the center. A situation may now arise where a negative potential well is formed near the center of the device. This potential well may be completely transparent to particle flow, and any (ion) particle trapped (i.e., having a kinetic energy smaller than that required to climb the potential) in this well may oscillate therein indefinitely, with a maximum kinetic energy at the very center of the well. These trapped ions may arise from scattered-beam ions or from ionization of fusion reactive gas that may be present in the device at some level. The thermal ions may now build to very high densities as the current amplification is limited only by the energy up-scattering times associated with the scenario. It should be understood that the virtual-electrode or alternating-potential effect just described is not necessary for the successful operation of fusion-generating devices in accordance with various embodiments of the present invention.

Another mode of operation which can, in some embodiments, enhance the efficiency of the fusion-generating device involves the temporally oscillatory manipulation of potentials and beams. For example, the entire fusion generating device may be pulsed to yield the same average power consumption, but substantially higher power production because of particle density spikes at certain time intervals. While the time average density remains the same as before, the instantaneous density may be brought very high. Because the fusion rate, in some embodiments, is proportional to the square of the density, the net effect will be a higher average fusion power output. For example, if the density is doubled from the steady state value at a duty cycle of 50 percent and the average input power is kept constant, the average fusion output power will double. It may be convenient to use this mode of operation to reduce the cooling requirements and overall complexity involved in high-power engineering. A small fusion generator (e.g., about 20 cm in diameter) may be difficult to operate in the megawatt regime. To take advantage of a higher efficiency at higher currents, yet remain in a lower kilowatt-range of operation, the machine may be pulsed with a short duty cycle at high instantaneous input powers.

If the high voltage power supply 306 is modulated at a frequency close to the transit time for an ion, or if electron injection and ion injection occur at relative timing intervals such that the ions and electrons can be forced to “sling-shot” off of each other, or by manipulating the injection/acceleration timing such that electrons experience an acceleration and subsequent confinement while ions see only the time-averaged electric field (due mainly to electrons), a multitude of operational modes may be employed, all of which serve to increase the efficiency of the device. Furthermore, it may be possible to excite compression waves by injecting ions at a resonant frequency with such an effect. This effect may lead to regions of enhanced density (spatial as well as temporal), which again may increase the efficiency of the device. Again, note that none of the aforementioned effects are necessary for the successful operation of the fusion device.

### 8. Experimental Example

A prototype of a fusion-generating device in accordance with one embodiment of the invention has been constructed and operated in a laboratory setup, which is shown in FIG. 13. To facilitate safe operation of the system, a concrete bunker 500 was built. This bunker serves to shield the operator from both x-rays and high-energy neutrons generated by fusion reactions. Power supplies and other equipment floating at high voltage, such as the power supplies used to bias the magnet repellers 322, 340 and electron emitters 354, 356, 358 are placed on top of the bunker 500 inside electrically isolated equipment racks 510, thereby keeping the dangerous voltages safely away from the operators. The racks 510 are brought up to high potential relative to the chamber by a high-voltage power supply 306. A high-voltage conduit 520 (aka feedthrough), which contains a portion of the stem connection 305, was constructed in the ceiling of the bunker 500, allowing direct connection between the high-voltage racks 510 on the roof of the bunker 500 and the high-voltage connections located at the top of the device 300 within the bunker.

Construction of the device 300 itself followed closely that described above. The device 300 includes a spherical vacuum chamber of approximately 18 inches in diameter about which ion sources are distributed at up to four of the ports. Ion reflectors with substantially identical electrostatic configuration (i.e., physical geometry and bias) are placed about the chamber opposite each ion source. The chamber itself is connected to electrical ground, and the ion sources are operated at or very near the ground potential. As needed, the sources and/or reflectors may be electrically isolated from the chamber so that certain electrical currents (e.g., net ion source currents) or potentials (e.g., reflector floating potentials) may be measured. The magnet assembly is electrically isolated form the chamber with the use of high-voltage feedthrough fabricated from cast resin and located at the top of the chamber. A 1600 l/sec turbo molecular vacuum pump is located at the bottom of the chamber. Additional ports about the chamber are included for diagnostic and observational access.

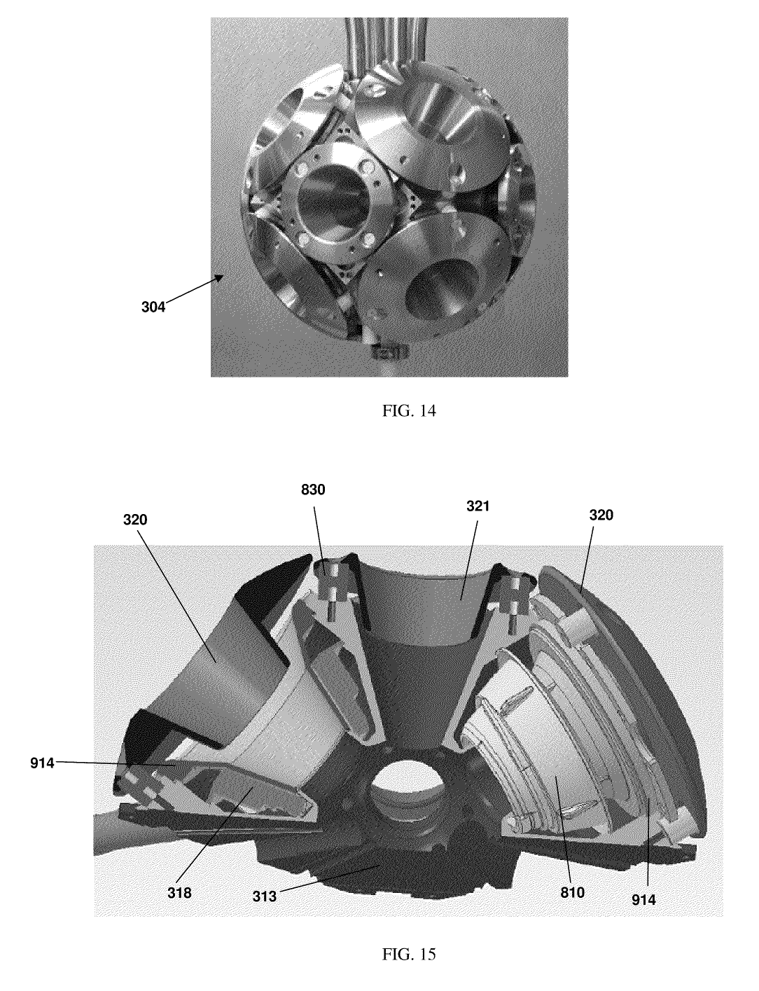

FIG. 14 depicts the magnet assembly 304 of the prototype device. The construction of the magnet assembly was likewise similar to that described above. However, instead of fabricating eight individual cones and then connecting them, the magnet in the prototype device was fabricated in two stainless steel “monoblock” hemispheres into which four conical cavities were machined. FIG. 15 shows a single hemisphere in partial cut-away view. The constructed magnet has an internal diameter of approximately 2.4 inches and an outer diameter (i.e., the furthest radial extent of the repellers) of approximately 7.8 inches. Instead of using a plastic winding carrier 800, the magnet coils 318 were initially wound around a form, and then potted with epoxy within a mold. After curing, the form and mold were removed, and the potted coil was incorporated into the magnet. The mold included details so that the cured epoxy on the coil formed standoffs and a separator ring such that, when the potted coil was placed into the conical cavity within the machined hemisphere, plenums were created that facilitate the flow of cooling water toward the center of the magnet down the inside conical surface of the coil and back away from the center of the magnet. After wiring the coils together in series (in order to assure identical current in each coil), each hemisphere was sealed using four inner cones 914, which sealed each potted magnet coil into the hemisphere block using conventional elastomeric o-rings 916. Two of these hemispheres were then bolted together, and repeller electrodes were attached to the assembly using alumina standoffs. Although still conical about the beam axis, the electron repellers 321 differ from those previously described in that their outer surfaces extend away from the axis outside of the magnet in such a way that these surfaces form a substantially spherical envelope about the outside of the magnet and centered on the magnet center. This extension serves to smoothen the electrostatic field, and thereby assist with the creation of stable electrostatic ion trapping.

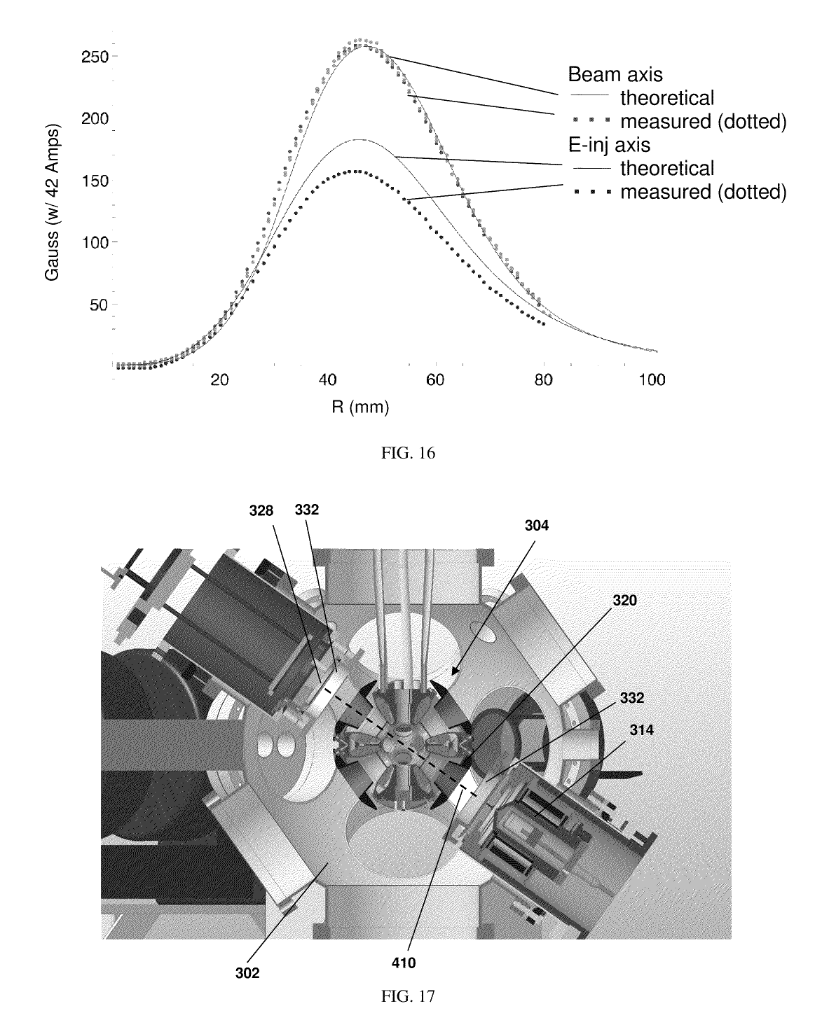

The magnetic field strength of the prototype magnet was measured at various points along the beam axis and a diagnostic axis parallel to the axis of electron injection. The measured field strength and the computationally predicted field strength are shown in FIG. 16. As can be seen, the beam axis field strength and profile closely match the theoretical values. Because the location of the magnetic coils in the prototype was somewhat different than the location that was modeled computationally, the diagnostic axis value differs to a greater extent from the predicted results, but the field strength and profile were still sufficient for the experiment.

The magnet was also operated with an integral electron emitter, and electron confinement performance was measured. Substantial magnetic confinement of electrons was measured when the peak magnetic field strength on the beam axis was above 125 Gauss and the repellers were not biased relative to the magnet (i.e., they were at the magnet potential). As a second test, the electron emitter was biased relative to the magnet at a sufficiently negative potential to maintain a constant current of 10 mA of electrons from the emitter (i.e., the emitter was biased in constant-current mode). The magnet was biased at negative 80 kV relative to the chamber, the repeller bias relative to the magnet was continuously swept from 0 V to negative 2 kV, and electron streaming losses from the magnet to the chamber were observed to drop from a base steaming current of 8 mA at 0V repeller bias to approximately 0 mA at around negative 1.5 kV repeller bias.

The complete beam line configuration of the prototype (for a single beam line) is shown in FIG. 17. The beam line includes the reflector 328, focusing ring (aka ion deselector 332), magnet assembly 304, and ion source 314. The ion beam axis 410 is indicated with a dashed line. This beam line was extensively modeled in various numerical simulation programs including Opera, LSP, and Lorentz. All of these codes indicated that this beam line configuration creates a stable electrostatic trap for recirculating ions. The simulations showed stability when the magnet 304 is biased at negative 100 kV, the ion axis repellers 320 are biased at negative 105 kV, the focusing ring electrode 332 is biased at 5 kV, and the chamber 302, reflectors 328, and ion source 314 are all biased at ground potential. FIG. 18 provides an example output of these simulations, which show a recirculating ion beam 930, demonstrating recirculation. The reflector 328, focusing ring 332, ion axis repellers 320, magnet body 313 and ion source 314 are shown as well. The drawing scale in millimeters is indicated by the vertical scale marker 940. This beam line was physically operated, and a focused ion beam was observed passing through the center of the magnet which was consistent with a well-focused electrostatic system. FIG. 19 illustrates the assembled prototype system 300 in perspective view (power supplies are not shown).

Having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A device for generating fusion reactions, the device comprising:
a cathodic magnet configured to generate a multi-poled magnetic field within an interior region thereof;
an anode surrounding the cathodic magnet;
located about the anode, at least one ion source configured to emit ions substantially toward a center of the interior region; and
located about the cathodic magnet, (i) at least one electron emitter configured to emit electrons into the interior region and (ii) at least one electron absorber configured to absorb electrons having energies exceeding an energy threshold from the interior region,
wherein the anode and the cathodic magnet are configured to generate an electric field therebetween for accelerating the ions substantially toward the center of the interior region.

2. The device of claim 1, wherein the at least one electron absorber is configured to reduce energy loss due to at least one of: (i) electron impact on the cathodic magnet; and (ii) electron escape from the interior of the cathodic magnet.

3. The device of claim 1, wherein the cathodic magnet comprises radially extending elements defining space-angular openings.

4. The device of claim 3, wherein an aspect ratio of the radially extending elements is at least 1.

5. The device of claim 3, wherein the radially extending elements are shaped substantially as envelopes of truncated cones.

6. The device of claim 3, wherein the radially extending elements comprise current-carrying wire coils.

7. The device of claim 3, wherein the at least one ion source is configured to emit ions through at least one of the space-angular openings into the interior region.

8. The device of claim 3, wherein the at least one electron absorber comprises a plate that is located near an inner radius of the radially extending elements.

9. The device of claim 3, wherein the plate comprises a ring plate aligned substantially coaxially with the space-angular openings.

10. The device of claim 1, further comprising at least one electron repeller located about the cathodic magnet.

11. The device of claim 10, wherein the cathodic magnet defines space-angular openings, and each of the at least one electron repeller is located proximate to one of the space-angular openings.

12. The device of claim 10, wherein the at least one electron repeller is negatively biased relative to the cathodic magnet.

13. The device of claim 1, further comprising at least one ion-deselector located at an interior of the anode.

14. The device of claim 13, wherein the at least one ion-deselector is negatively biased relative to the anode.

15. The device of claim 1, further comprising at least one secondary ion source located about the cathodic magnet and configured to emit fusion fuel into the interior region.

16. The device of claim 1, further comprising at least one source of neutral fusion gas located about the anode.

17. The device of claim 1, wherein the cathodic magnet has a polyhedral topology.

18. The device of claim 17, wherein the cathodic magnet and the at least one electron emitter are configured to concentrate electrons about the center of the interior region and about centers of the faces of the polyhedron.

19. The device of claim 1, wherein the ions comprise at least one member selected from the group consisting of protons, deuterons, tritons, helium-3 ions, boron-11 ions, and lithium ions.

20. The device of claim 1, wherein the at least one electron emitter is configured to additionally serve as the at least one electron absorber.

21. A device for generating fusion reactions, the device comprising:
a cathodic magnet configured to generate a multi-poled magnetic field within an interior region thereof, the cathodic magnet defining openings at faces of a polyhedron;
an anode surrounding the cathodic magnet;
located about the anode, at least one ion source configured to emit ions substantially toward a center of the interior region; and
located about the cathodic magnet, at least one electron emitter configured to emit electrons into the interior region,
wherein (i) the anode and the cathodic magnet are configured to generate an electric field therebetween for accelerating the ions substantially toward the center of the interior region, and (ii) the cathodic magnet and the at least one electron emitter are configured to concentrate electrons about the center of the interior region and about centers of the faces of the polyhedron.

22. The device of claim 21, wherein the concentrated electrons about the centers of the faces of the polyhedron are configured to concentrate the ions onto paths substantially coinciding with axes of the polyhedron.

23. The device of claim 21, wherein the concentrated electrons about the centers of the faces of the polyhedron are configured to focus the ions into a region about the center of the cathodic magnet.

24. A device for generating fusion reactions, the device comprising:
a cathodic magnet configured to generate a multi-poled magnetic field within an interior region thereof;
an anode surrounding the cathodic magnet;
located about the anode, at least one primary ion source configured to emit ions substantially toward a center of the interior region; and
located about the cathodic magnet, at least one electron emitter configured to emit electrons into the interior region and at least one secondary ion source configured to emit fusion fuel into the interior region,
wherein (i) the anode and the cathodic magnet are configured to generate an electric field therebetween for accelerating the ions substantially toward the center of the interior region, and (ii) the at least one electron emitter, the at least one secondary ion source, and the cathodic magnet are configured so that a substantially neutral plasma formed by the electrons and the fusion fuel is substantially confined within the interior region.

25. The device of claim 24, wherein the electric field is configured to accelerate the ions to a hot-ion temperature, and a temperature of the substantially neutral plasma is lower than the hot-ion temperature.

26. The device of claim 24, wherein the fusion fuel comprises at least one of ions, neutral atoms, and neutral molecules.

27. A method for generating fusion reactions, comprising:
using a device for generating fusion reactions, the device comprising:
a cathodic magnet configured to generate a multi-poled magnetic field within an interior region thereof;
an anode surrounding the cathodic magnet;
located about the anode, at least one ion source configured to emit ions substantially toward a center of the interior region; and
located about the cathodic magnet, (i) at least one electron emitter configured to emit electrons into the interior region and (ii) at least one electron absorber configured to absorb electrons having energies exceeding an energy threshold from the interior region,
wherein the anode and the cathodic magnet are configured to generate an electric field therebetween for accelerating the ions substantially toward the center of the interior region.

28. The method of claim 27, the method comprising generating the multi-poled magnetic field.

29. The method of claim 27, the method comprising emitting electrons into the interior region of the cathodic magnet.

30. The method of claim 27, the method comprising absorbing electrons having energies exceeding an energy threshold from the interior region.

31. The method of claim 27, the method comprising injecting ions substantially toward the center of the interior region.

32. The method of claim 27, the method comprising generating the electric field between the anode and the cathodic magnet.

33. The method of claim 27, the method comprising reducing energy loss due to at least one of: (i) electron impact on the cathodic magnet; and (ii) electron escape from the interior of the cathodic magnet.

34. The method of claim 27, the method comprising emitting fusion fuel into the interior region.

35. The method of claim 34, the method comprising forming a neutral plasma including the electrons and the fusion fuel.

36. The method of claim 27, the method comprising concentrating electrons about the center of the interior region and about centers of the faces of the polyhedron.

37. The method of claim 27, the method comprising at least one of: (i) concentrating the ions onto paths substantially coinciding with axes of the cathodic magnet; and (ii) focusing the ions into a region about the center of the cathodic magnet.

38. A device for generating fusion reactions, the device comprising:
a cathodic magnet configured to generate a multi-poled magnetic field within an interior region thereof;
an anode surrounding the cathodic magnet;
at least one source of ions or ion precursors; and
located about the cathodic magnet, (i) at least one electron emitter configured to emit electrons into the interior region and (ii) at least one electron absorber configured to absorb electrons having energies exceeding an energy threshold from the interior region,
wherein the anode and the cathodic magnet are configured to generate an electric field therebetween for accelerating the ions substantially toward the center of the interior region.

39. The device of claim 38, wherein the source of ions or ion precursors comprises a source of neutral fusion gas.

40. The device of claim 39, wherein the source of ions or ion precursors further comprises means for ionizing the neutral fusion gas.

41. The device of claim 38, wherein the source of ions or ion precursors is configured to emit the ions or ion precursors substantially toward a center of the interior region.

42. A device for generating fusion reactions, the device comprising:
a cathodic magnet configured to generate a multi-poled magnetic field within an interior region thereof, the cathodic magnet defining openings at faces of a polyhedron;
an anode surrounding the cathodic magnet;
at least one source of ions or ion precursors; and
located about the cathodic magnet, at least one electron emitter configured to emit electrons into the interior region,
wherein (i) the anode and the cathodic magnet are configured to generate an electric field therebetween for accelerating the ions substantially toward the center of the interior region, and (ii) the cathodic magnet and the at least one electron emitter are configured to concentrate electrons about the center of the interior region and about centers of the faces of the polyhedron.

43. A device for generating fusion reactions, the device comprising:
a cathodic magnet configured to generate a multi-poled magnetic field within an interior region thereof;
an anode surrounding the cathodic magnet;
primary and secondary sources of fusion fuel;
located about the anode, at least one primary ion source configured to emit ions substantially toward a center of the interior region; and
located about the cathodic magnet, at least one electron emitter configured to emit electrons into the interior region and at least one secondary ion source configured to emit fusion fuel into the interior region,
wherein (i) the anode and the cathodic magnet are configured to generate an electric field therebetween for accelerating the ions substantially toward the center of the interior region, and (ii) the at least one electron emitter, the at least one secondary ion source, and the cathodic magnet are configured so that a substantially neutral plasma formed by the electrons and the fusion fuel is substantially confined within the interior region.

44. The device of claim 43, wherein the primary source of fusion fuel comprises at least one ion source located about the anode and configured to emit ions substantially toward a center of the interior region.

45. The device of claim 44, wherein the secondary source of fusion fuel comprises at least one source of neutral fusion gas.

46. The device of claim 44, wherein the secondary source of fusion fuel comprises at least one ion source located about the cathodic magnet and configured to emit ions toward the center of the interior region.

47. The device of claim 43, wherein the primary and secondary sources of fusion fuel are sources of neutral fusion gas, the primary source is located about the anode, and the secondary source is located about the cathodic magnet.
